SEQUENCE LISTING (24 sequences)

SEQ ID NO: 1 - protein, 318 aa, Arabidopsis thaliana
MSSSSSRNAFEDGKYKSNLLTLDSSSRCCKITPSSRASPSPPKQLLVATPVEEGDYPVVMLLHGYLLYNSFYSQLMLHVSSHGFILIAPQLYSIAGPDTMDEIKSTAEIMDWLSVGLNHFLPAQVTPNLSKFALSGHSRGGKTAFAVALKKFGYSSNLKISTLIGIDPVDGTGKGKQTPPPVLAYLPNSFDLDKTPILVIGSGLGETARNPLFPPCAPPGVNHREFFRECQGPAWHFVAKDYGHLDMLDDDTKGIRGKSSYCLCKNGEERRPMRRFVGGLVVSFLKAYLEGDDRELVKIKDGCHEDVPVEIQEFEVIM

SEQ ID NO: 2 - protein, 319 aa, Triticum aestivum
MAAAAPAETMNKSAAGAEVPEAFTSVFQPGKLAVEAIQVDENAAPTPPIPVLIVAPKDAGTYPVAMLLHGFFLHNHFYEHLLRHVASHGFIIVAPQFSISIIPSGDAEDIAAAAKVADWLPDGLPSVLPKGVEPELSKLALAGHSRGGHTAFSLALGHAKTQLTFSALIGLDPVAGTGKSSQLQPKILTYEPSSFGMAMPVLVIGTGLGEEKKNIFFPPCAPKDVNHAEFYRECRPPCYYFVTKDYGHLDMLDDDAPKFITCVCKDGNGCKGKMRRCVAGIMVAFLNAALGEKDADLEAILRDPAVAPTTLDPVEHRVA

SEQ ID NO: 3 - DNA, 984 bp, Triticum aestivum
gcgcgcaggctgctggaaaaatggcagcggctgccccggccgaaacaatgaataaaagcgcagcgggtgccgaagttcctgaagcatttacgtctgtgtttcaaccgggcaaattggctgtcgaagccattcaggtagacgaaaacgctgcccctacaccgcctattccggtcctgatcgtagcacctaaagatgcgggaacgtatccggtcgcgatgctgcttcatggctttttcctgcataaccatttttacgaacatttgttgcgtcatgtcgcgtcccatggatttatcatcgtagctcctcaattttcaattagcattatcccgtcaggcgacgcggaagatatcgcagcggctgccaaagttgctgactggctgccggatggccttcctagcgttttaccgaaaggcgttgaacctgaactttctaaactggctcttgccggacattcccgcggcggacatacagctttttcattagccttgggccatgcaaaaacacagttaacgttttctgccctgattggacttgatccggttgcaggtacaggcaaatcaagccaattgcagcctaaaatcctgacgtatgaaccgtcttcctttggcatggctatgcctgttcttgtgattggaacaggtttgggcgaagaaaagaaaaatattttctttccgccgtgcgccccgaaagatgttaaccatgcagaattttatcgtgaatgccggccgccttgttattactttgtgacaaaagactacggacatttagatatgttggatgacgatgcaccgaaatttattacgtgcgtctgtaaagatggaaatggttgcaaaggtaaaatgagacgctgtgtcgcgggcattatggtagcatttctgaacgcagcgctgggcgaaaaagacgcggatcttgaagctatcttaagagacccggcagttgcgccgacaacgcttgatccggttgaacatcgcgtggcttaattaa

SEQ ID NO: 4 - protein, 322 aa, Chlamydomonas reinhardtii
MPSTQFLGASTLLLFGLRAVMSSDDYIKRGDLPTSKWSGRVTLRVDSAMAVPLDVVITYPSSGAAAYPVLVMYNGFQAKAPWYRGIVDHVSSWGYTVVQYTNGGLFPIVVDRVELTYLEPLLTWLETQSADAKSPLYGRADVSRLGTMGHSRGGKLAALQFAGRTDVSGCVLFDPVDGSPMTPESADYPSATKALAAAGRSAGLVGAAITGSCNPVGQNYPKFWGALAPGSWQMVLSQAGHMQFARTGNPFLDWSLDRLCGRGTMMSSDVITYSAAFTVAWFEGIFRPAQSQMGISNFKTWANTQVAARSITFDIKPMQSPQ

SEQ ID NO: 5 - DNA, 997 bp, Chlamydomonas reinhardtii
gcgcgcaggctgctggaaaaatgccttctacacaatttcttggagcatccacgctgcttttatttggtttacgtgcggtcatgtcaagcgatgactatattaaacggggtgatttgccgacatcaaaatggagcggaagagtcacgttgcgcgtagattcagctatggccgttccgctggacgttgtgatcacatatccttcttccggcgcagcggcttatccggtcctggtaatgtacaatggatttcaggcaaaagcgccgtggtacagaggcattgttgatcatgtgtcaagctggggatatacagtcgtacaatacacgaacggcggactttttcctatcgttgtggaccgcgtcgaacttacatatttagaaccgttgctgacatggttagaaacgcagtctgctgatgccaaatccccgttgtacggcagagctgacgtatcacgcctgggcacaatgggacatagcagaggtggcaaattggccgcactgcaatttgcgggccgcacggatgtttcaggatgcgtgctttttgatcctgtggacggcagcccgatgacacctgaatcagctgactatccgagcgctacgaaagcacttgcggctgccggacgttctgccggtttagttggcgcagcgattacaggttcatgtaatccggtgggccagaactaccctaaattttggggagcattggcgcctggttcatggcaaatggtcctgagccaggcaggccatatgcaatttgcgagaacaggaaatccgtttttagattggagccttgaccgtttatgcggacggggtacgatgatgtcttccgatgtcatcacatattctgctgcctttacggtagcttggtttgaaggcatttttcgtccggcccaatctcagatgggaatctccaattttaaaacatgggcaaacacgcaagttgcagcgcggtctattacatttgatatcaaaccgatgcaatcccctcagtaattaattaa

SEQ ID NO: 6 - protein, 484 aa, Arabidopsis thaliana
MEIISLNVVPQCSVVTWSSKLATKRLVPNRSSLLFSGVKKSRLVIRSGNSDGYVVGENDDLGRIARRGESTSKVLIPGLPDESNGEIAARISHSHCEWKPKLRVHYEKAGCDNLDAPAVLFLPGFGVGSFHYEKQLTDLGRDYRVWAIDFLGQGLSLPTEDPTTMTEETSSSEDKEPFWGFGDKTEPWADQLVFSLDLWRDQVQYFVEEVIGEPVYIAGNSLGGYVALYFAATHPHLVKGVTLLNATPFWGFFPNPVRSPKLARLFPWPGAFPLPERVKKITELVWQKISDPESIAEILKQVYTDHSINVDKVFSRIVEVTQHPAAAASFASIMLAPGGELSFSEALSRCKENNVQICLMYGREDPWVRPLWGKKIKKEIPNAPYYEISPAGHCPHDEVPEVVNYLMRGWIKHLESGGFEALPLLEDTEEDWEESRIGREIEFPRDGWKKAVNLWLYGSNYTYWRGVRESFRSSFIRVFGGKSA

SEQ ID NO: 7 - DNA, 1853 bp, Arabidopsis thaliana
aacccaattcttctatttcttcttcacctttagatttttcctcgcttaatttctcaataacgctctcagagagaccatttgatgaagcttctcgcttctggaatttgaaaaggatttgataagacgagttcatagaagattaccgcaagttcatcaactttttgaacttgttatggagataatctcactgaacgttgtgccccagtgctctgtggttacttggagtagtaaattagcaacgaaaagattggtcccaaatcggtcaagtttgttattctcaggggtcaaaaaatccagacttgtgattcgaagtggaaattccgatggttatgttgttggtgagaatgatgacttgggtcgtatagccagaagaggagaatcaacgtcaaaggttttgattcctggtttgcctgatgaatcaaatggtgaaattgctgctcgaatcagtcattctcactgcgagtggaagcccaagcttagagtacattatgagaaagccggttgtgacaatctcgatgctcctgcggtgttgtttcttcctggctttggcgttggttcatttcactatgagaagcagcttaccgatttgggaagggattatcgagtatgggctattgattttcttggacagggtttatctctccctactgaagatcctactaccatgactgaagaaaccagttcctcggaagataaggaaccattttggggatttggtgacaaaactgaaccgtgggctgatcaacttgtattctctctggatctctggagggatcaagttcagtattttgtagaagaggttatcggtgagcctgtgtacattgcagggaactcacttggagggtatgtagctctctactttgcagcaacccatcctcacctggttaagggtgttaccttgcttaatgcaacacctttctggggtttcttccctaatccagtaagatccccaaagctagcacgtctctttccatggcccggagcattccctctgccggaaagagtgaaaaaaatcacagaattggtgtggcaaaagataagtgatcctgaaagcatagctgagatacttaaacaggtctacacagaccattctatcaatgtggataaagtattctcacgtattgtggaggtcacacagcatccggctgctgcagcatcgtttgcttcaatcatgcttgctcctggtggagagctatctttctccgaagctttatctaggtgtaaggaaaacaatgttcagatatgtctcatgtatggaagagaagatccatgggtgagaccgttatggggaaagaagataaagaaggaaatccccaacgctccatactacgagatcagcccagcgggtcactgcccacacgatgaagtccctgaggtggtgaactatctgatgcgcgggtggatcaagcacctggagtctggtggttttgaagcgctcccgcttttggaggacactgaagaagattgggaggagtccaggattggtagagaaattgagttcccgagagatggttggaaaaaagcagtgaatctgtggttatatgggtcaaactatacgtactggagaggagttagagaatctttcagatccagttttataagggtgtttggagggaagtctgcatagaagaagcatggaacagtcgtctagtgtaaattaattgtaatctatgttgcatccgatgctagctatataatgttgtctgtagaatcaagtttctaaaatgttcaaaaggaaaagttagaaaaatatctacttgatagttagtcacctaaatcgaaggaactcctttcttgcattgttgtatataatccacaggttcagattaatataggaaggcgacattgcaggc

SEQ ID NO: 8 - protein, 566 aa, Populus trichocarpa
MMILAFFLIFMEFYFQLRRRYASYLLINMILLITADQPFWGMEILTSSTASCCLVVNLRWKLAENGSNSSQLKLPTSRERKILFARTNQRNGSLRFSSVDKFLKKLNHGKGSRSLDSFGGLKNGNSKVFSGNSSSYVVGGEDDVGSITENGESPTKVLIPGLPDESNGEYSAPVSSCFWKWKPKLNVHYEKAGCENVNSPPVLFLPGFGVGSFHYEKQLKDLGRDYRVWAIDFLGQGMSLPVENPTLFSKDGAASEGKDSIWGFGDEIEPWANDLVFSMDLWQDQVHNFIEEVIGEPVYIVGNSLGGFVALYFAARYPHLVKGVTLLNATPFWGFLPNPIRSPRLARIFPWSGTFPLPANVRKLIAFFWQKISDPKSIAEILKQVYTDHSTNIDKVFSRILEITQHPAAAASFASIMFAPQGQLSFRETLARCKMSDTPICLVYGKEDPWVKPVWGLQVKQQVPEAPYYEISPAGHCPHDEVPEAVNYLLRGWIKNLESHGSVALPLHEDAEVVENSFAMDLEFVREGSRKSVIVRFFGSRFSIWNSFSSYIKSQFKETTSRILTP

SEQ ID NO: 9 - protein, 524 aa, Vitis vinifera
MEILSCHSAPCCKLVNLGGTSVHKSSGSSQAKLPGSRNNRILCARIGSKLGSSGYSNLDDFCTKNFGRHEGSRSLTAFKGSANVNSKALSESYNGYVIDGKEGVGDISERGDLITQILIPGLPDDSNDDSGAQISSCFWEWKPKLTVHYEKSGCENVNSPPVLFLPGFGVGSFHYEKQLKDLGRDFRVWAVDFLGQGMSLPFEDPAPQSKKELDSERNDFSWGFGDETEPWANELVYSIDLWQDQVRYFIEQVIGEPVYIVGNSLGGFVALYFAACNPQLVKGVTLLNATPFWGFLPNPSRSPSLARIFPWAGTFPLPAFVRKLTEFVWQKISDPRSIGEVLKQVYADHSTKVDKVFSRILETTQHPAAAASFASIMFAPQGQLSFSEALSRCQMSNVPICLMYGKEDPWVRPVWGLQVKRQLLEAPYYEISPAGHCPHDEVPEVVNYLLRGWIGNLESKGSVTLPLLDDPENIQYGTTKDLEFVREGSKKSVRVHFYGSRFSLWNRIRSYVKSRFEALEINSR

SEQ ID NO: 10 - protein, 481 aa, Ricinus communis
MFSPCPLISSGQTQWLDLGMDILTFNVTTSHRTAHFGSKLVDKTKYSCKSKVSTIIKPQVFCARIDQSCGLLRFSSSNKFLDYPKKIEVSKKHNALKGIKVVNSKVLSGNYNGYVIEADEDMESVSGSGESTPEILIPGLPNESSGECGAPINSCFWEWKPKLYVHYEKAGCENVKSPPVLFLPGFGVGSFHFENQLKDLGRDYRVWAIDFLGQGMSLPVENPTLQLREGDILEGKNSFWGFGDETEPWANELVYSMDLWRDQVRYFIEEVIGEPVYVVGNSLGGFVAIYFAASNPQLVKGVTLLNATPFWGFLPNPIRSPRLARIIPWSGTFPLPASVRKLTEFFWQKISDPKSIAQVLKQVYADHSTNVDQVFSRILKITQHPAAAASFASIMFAPQGQLSFRECLMRCKMNNLPICLLYGREDPWVKPIWGLQVKRQVPEASYYEISPAGHCPHDEVPEVCSLSLFLVGIPLLFLVIL

SEQ ID NO: 11 - protein, 486 aa, Oryza sativa
MEVVSSSHSCLAFNRTPSSAWRFPGNGLGPGHAKLTRPRSAILCVRSGTASNPADSGKVHASHGFYVSDVDAALQGIPKKVGEIEKMIIPSLPEGPESSLISTGFWEWKPKLSVYYEKSGIDNSKAPSVLFLPGFGVGTFHFEKQLKDLGRDYKVWTMDFLGQGMSLPCEDPAPKSTSGELDEDTYWGFGQELQPWAEELVYSIDLWRDQVQHFIEEVIGEPVYIVGNSLGGFVSLYLAASCPHLVKGVTLLNATPFWGFLPNPATSPRLSKIFPWAGTFPLPSFVRKLTETVWQKISDPRSIQGILKQVYADHSTNVDMVFSRIIETTQHPAAAASFASIMCAPKGQISFEEALSRCQRQGIPISLMYGREDPWVRPIWGIKVKQQVPESPYYEISPAGHCPHDEVPEVINYLLRGWLKNVESEGSVAVPFLEEPSYAENGVSRELEFVRGGSKKSVHVRLFGSKISLWSQLRSLLKSNTWVISR

SEQ ID NO: 12 - protein, 491 aa, Zea mays
MEVVSCSHSCSALHQTPASTWRLRGSALGLGLGHARPSRTRRYTVACVGTTSGASNPGGSGKVHAAQGFHVSDVDAALQGIPSMKAGEAERVMIQGLPEGPDSSPISTGFWEWKPKLTVHYERSGMKNSKAPAVLFLPGFGVGTFHFEKQLRDLGRDHRVWTMDFLGQGMSLPGEDPAPSSIASEDAFWGFGQDSQPWAEELVYSVDLWQNQVQHFIEEVIREPVYIVGNSLGGFVALYFAASSPHLVKGVTLLNATPFWGFFPNPATSPRLSKIFPWAGTFPLPSFVRKITEAVWQKISDPKSIQDILKQVYADHSTNVDKVFSRIVEITQHPAAAASFASIMFAPRGQISFQEAISRCQDQGIPISLMYGREDPWIRPIWGLKVKQQVPEAPYYEISPAGHCPHDEVPEVINYLLRGWLKNLESEGSVDLPFLEERSYAERGVSRELEFVREGSRKSVSVRLYGTKISLWSQLSSFLNTRVPKSRIVLR

SEQ ID NO: 13 - protein, 505 aa, Nicotiana tabacum
MEVHSCYSTTYYCIVNVSKCLISNQAKFPIVKERRLYSGLDVYSIKKKRTQRLTITALKGFDSVDSSLLSESYNSDIIDGKVGTQDVIGSAKSVPKVIVPSLPDETKADSVAVVDSCLWEWKPKLKVHYEKSGCQNVNSAPILFLPGFGVGSFHYEKQLKDLGCDHRIWALDFLGQGKSLPCEDPTLQSKRLDESERDGNNAVWGFGDEAEPWAKELVYSVDLWRDQVRYFIEEVIKEPVYIVGNSLGGYVALYLAAYYPQLVKGVTLLNATPFWGFLPNPVRSPRLSRLFPWAGTFPLPDTIRKLTELVWQKISAPESIAEVLKQVYADHTTKVDKVFSSILEVTEHPAAAASLASILFAPRGQLSFKEALTGCRMNNVPVCLMYGKEDPWVMPFWALQVKRQLPEAPYYQISPAGHCPHDEVPEIVNFLLRGWIKNIESHSSVALPLLDSPESIEYDIVRDLEFVRQGMKKSVRVQFYGSMTSQWEKLGMFLKSRFQYGVYSP

SEQ ID NO: 14 - protein, 426 aa, Oryza sativa
MEVVSSSHSCLAFNRTPSSAWRFPGNGLGPGHAKLTRPRSAILCVRSGTASNPADSGKVHASHGFYVSDVDAALQGIPKKVGEIEKMIIPSLPEGPESSLISTGFWEWKPKLSVYYEKSGIDNSKAPSVLFLPGFGVGTFHFEKQLKDLGRDYKVWTMDFLGQGMSLPCEDPAPKSTSGELDEDTYWGFGQELQPWAEELVYSIDLWRDQVQHFIEEVIGEPVYIVGNSLGGFVSLYLAASCPHLVKGVTLLNATPFWGFLPNPATSPRLSKIFPWAGTFPLPSFVRKLTETVWQKISDPRSIQGILKQVYADHSTNVDMVFSRIIETTQHPAAAASFASIMCAPKGQISFEEALSRCQRQGIPISLMYGREDPWVRPIWGIKVKQQVPESPYYEISPAGHCPHDEVPEVPGKSLAWWITGRLQAS

SEQ ID NO: 15 - protein, 337 aa, Physcomitrella patens subsp. patens
IASHIWEWRHRWNIHYECAGTSLNTNAPAMLLLPGFGVGSFHYHQQLRDLGQEYRVWAIDFLGQGKSWPSHDPAPEEAEEVVEEIRHWSLGKNPEPWAEGLVYSVDTWRDQVHAFIEKVIGGPVYIVGNSLGGYVGSYFAATNPELVKGVTLLNATPFWAFTPNSRRYPLLSKLTPWGGLLPVPIFAKAIIRFWWDLLRNPSTIRNMLGAVYANRSAINKKLITQIIEATDHPAAFAAFASIVFAPRAHTDFGENLISLKERRMPMCMIYGKEDPWVVPFWGQRAKQRNPDAIYYELSPAGHCPHHEAPEVLFPAQIVLLACMVQNIIGKARPLFKG

SEQ ID NO: 16 - protein, 7 aa, Artificial Sequence
  Conserved sequence motif
LPGFGVG

SEQ ID NO: 17 - protein, 6 aa, Artificial Sequence
  Conserved sequence motif
DFLGQG

SEQ ID NO: 18 - protein, 6 aa, Artificial Sequence
  Conserved sequence motif
GNSLGG

SEQ ID NO: 19 - protein, 14 aa, Artificial Sequence
  Conserved sequence motif
LVKGVTLLNATPFW

SEQ ID NO: 20 - protein, 4 aa, Artificial Sequence
  Conserved sequence motif
HPAA

SEQ ID NO: 21 - protein, 4 aa, Artificial Sequence
  Conserved sequence motif
EDPW

SEQ ID NO: 22 - protein, 8 aa, Artificial Sequence
  Conserved sequence motif
SPAGHCPH

SEQ ID NO: 23 - protein, 285 aa, Aeromonas salmonicida
ADTRPAFSRIVMFGDSLSDTGKMYSKMRGYLPSSPPYYEGRFSNGPVWLEQLTKQFPGLTIANEAEGGATAVAYNKISWDPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNKLLLNLARQLAPTGMVKLFEIDKQFAEMLRDPQNFGLSDVENPCYDGGYVWKPFRSASPRSASPLNCEGKMFWDQVHPTTVVHAALSERAATFIETQYEFLAHG

SEQ ID NO: 24 - protein, 4 aa, Artificial Sequence
  Conserved sequence motif
GDSX

(19) United States
(12) Patent Application Publication
(10) Pub. No.: US 2013/0085287 A1
(43) Pub. Date: Apr. 4, 2013

(54) PROCESS

(71) Applicants: Rene Mikkelsen, Skandeborg (DK); Tina Lilian Jorgensen, Silkeborg (DK); Jorn Borch Soe, Tilst (DK)

(72) Inventors: Rene Mikkelsen, Skandeborg (DK); Tina Lilian Jorgensen, Silkeborg (DK); Jorn Borch Soe, Tilst (DK)

(73) Assignee: DUPONT NUTRITION BIOSCIENCES APS, Copenhagen K (DK)

(21) Appl. No.: 13/702,706

(22) PCT Filed: Jun. 16, 2011
(86) PCT No.: PCT/IB11/52623

§ 371 Date: Dec. 7, 2012

Related U.S. Application Data
(60) Provisional application No. 61/356,031, filed on Jun. 17, 2010.

(30) Foreign Application Priority Data
Jun. 18, 2010 (EP) 10166495.1

(51) Int. Cl. C11B 3/00

(52) U.S. Cl. CPC C11B 3/003
USPC 554/1; 435/271

(57) ABSTRACT

In one aspect the present invention provides a process for treating oil-containing seeds, comprising a step of contacting the seeds with an enzyme which is capable of hydrolysing chlorophyll or a chlorophyll derivative. Also provided are a method for obtaining oil from plant seeds and a process for producing a refined plant oil comprising such a treatment. Further provided are crude and refined plant oils obtainable from the processes and methods.

### FIELD

The present invention relates to the field of oil extraction from plant seeds. In particular, the invention relates to a process for treating plant seeds, which may be used to reduce the content of chlorophyll and related compounds in oil obtained from the seeds.

### BACKGROUND

Oil may be extracted from plant seeds using various methods. The oil is usually pressed out of the seed or extracted with organic solvents after crushing of the seed. A combination of pressing and organic extraction may be used, e.g. the oil component remaining in the pressed seeds is extracted with organic solvents after a pressing step. If the pressed seeds are intended to be used as animal feed, organic solvents should not be used. The pressed seed cake preferably has a low residual oil content and a high protein content making it particularly suitable as a feed material.

The extraction method using organic solvents suffers from the drawbacks of high cost and health risks associated with the use of compounds such as hexane. Furthermore, oil obtained using the extraction method typically contains high amounts of phospholipids, which must be removed by a degumming process before use as an edible oil or biodiesel. Another disadvantage of the extraction method is that the oil typically contains high amounts of coloured pigments such as chlorophyll, which must also be removed during oil processing.

For these reasons, oils may be produced from, for example, rapeseed by expeller pressing of the seeds without organic extraction. Although the pressing method typically results in a lower chlorophyll (and phospholipid) content of the crude oil than for organic extraction, chlorophyll and related coloured pigments still need to be removed from the oil during processing.

For example, crude vegetable oils derived from oilseeds such as soybean, palm or rape seed (canola), cotton seed and peanut oil typically contain some chlorophyll. Chlorophyll imparts an undesirable green colour and can induce oxidation of oil during storage, leading to a deterioration of the oil.

Various methods have been employed in order to remove chlorophyll from vegetable oils. Chlorophyll may be removed during many stages of the oil production process, including the seed crushing, oil extraction, degumming, caustic treatment and bleaching steps. However the bleaching step is usually the most significant for reducing chlorophyll residues to an acceptable level. During bleaching the oil is heated and passed through an adsorbent to remove chlorophyll and other colour-bearing compounds that impact the appearance and/or stability of the finished oil. The adsorbent used in the bleaching step is typically clay.

In the edible oil processing industry, the use of such steps typically reduces chlorophyll levels in processed oil to between 0.02 to 0.05 ppm. However the bleaching step increases processing cost and reduces oil yield due to entrainment in the bleaching clay. The use of clay may remove many desirable compounds such as carotenoids and tocopherol from the oil. Moreover, recent studies have shown that bleaching clay can contaminate oil with chloride ions. This leads to the formation 3-monochloropropane-1,2-diol (3-MCPD), which is very toxic. Also the use of clay is expensive, this is particularly due to the treatment of the used clay (i.e. the waste) which can be difficult, dangerous (prone to self-ignition) and thus costly to handle. Thus attempts have been made to remove chlorophyll from oil by other means, for instance using the enzyme chlorophyllase.

In plants, chlorophyllase (chlase) is thought to be involved in chlorophyll degradation and catalyzes the hydrolysis of an ester bond in chlorophyll to yield chlorophyllide and phytol. WO 2006009676 describes an industrial process in which chlorophyll contamination can be reduced in a composition such as a plant oil by treatment with chlorophyllase. The water-soluble chlorophyllide which is produced in this process is also green in colour but can be removed by an aqueous extraction or silica treatment.

Chlorophyll is often partly degraded in the seeds used for oil production as well as during extraction of the oil from the seeds. One common modification is the loss of the magnesium ion from the porphyrin (chlorin) ring to form the derivative known as pheophytin (see FIG. 1). The loss of the highly polar magnesium ion from the porphyrin ring results in significantly different physico-chemical properties of pheophytin compared to chlorophyll. Typically pheophytin is more abundant in the oil during processing than chlorophyll. Pheophytin has a greenish colour and may be removed from the oil by an analogous process to that used for chlorophyll, for instance as described in WO 2006009676 by an esterase reaction catalyzed by an enzyme having a pheophytinase activity. Under certain conditions, some chlorophyllases are capable of hydrolyzing pheophytin as well as chlorophyll, and so are suitable for removing both of these contaminants The products of pheophytin hydrolysis are the red/brown-colored pheophorbide and phytol. Pheophorbide can also be produced by the loss of a magnesium ion from chlorophyllide, i.e. following hydrolysis of chlorophyll (see FIG. 1). WO 2006009676 teaches removal of pheophorbide by an analogous method to chlorophyllide, e.g. by aqueous extraction or silica adsorption.

Pheophytin may be further degraded to pyropheophytin, both by the activity of plant enzymes during harvest and storage of oil seeds or by processing conditions (e.g. heat) during oil refining (see “Behaviour of Chlorophyll Derivatives in Canola Oil Processing”, JAOCS, Vol, no. 9 (September 1993) pages 837-841). One possible mechanism is the enzymatic hydrolysis of the methyl ester bond of the isocyclic ring of pheophytin followed by the non-enzymatic conversion of the unstable intermediate to pyropheophytin. A 28-29 kDa enzyme from Chenopodium album named pheophorbidase is reportedly capable of catalyzing an analogous reaction on pheophorbide, to produce the phytol-free derivative of pyropheophytin known as pyropheophorbide. Pyropheophorbide is less polar than pheophorbide resulting in the pyropheophoribe having a decreased water solubility and an increased oil solubility compared with pheophorbide.

Depending on the processing conditions, pyropheophytin can be more abundant than both pheophytin and chlorophyll in vegetable oils during processing (see Table 9 in volume 2.2. of Bailey's Industrial Oil and Fat Products (2005), 6^{th} edition, Ed. by Fereidoon Shahidi, John Wiley & Sons). This is partly because of the loss of magnesium from chlorophyll during harvest and storage of the plant material. If an extended heat treatment at 90° C. or above is used, the amount of pyropheophytin in the oil is likely to increase and could be higher than the amount of pheophytin. Chlorophyll levels are also reduced by heating of oil seeds before pressing and extraction as well as the oil degumming and alkali treatment during the refining process. It has also been observed that phospholipids in the oil can complex with magnesium and thus reduce the amount of chlorophyll. Thus chlorophyll is a relatively minor contaminant compared to pyropheophytin (and pheophytin) in many plant oils.

There is a still a need for an improved process for removing chlorophyll and chlorophyll derivatives such as pheophytin and pyropheophytin from plant oils. In particular, there is a need for a process in which chlorophyll and chlorophyll derivatives are removed with enhanced efficiency, whilst reducing the loss of other desirable compounds from the oil.

### SUMMARY

Accordingly, in one aspect the present invention provides a process for treating oil-containing seeds, comprising a step of contacting the seeds with an enzyme which is capable of hydrolysing chlorophyll or a chlorophyll derivative.

In one embodiment, the seeds are flaked, peeled or crushed before contacting with the enzyme. Preferably the seeds comprise seed flakes having a thickness of about 0.1 to 0.5 mm

In one embodiment, the enzyme is sprayed onto the seeds in an aqueous solution.

The enzyme may comprise, for example, a chlorophyllase, pheophytinase, pyropheophytinase or pheophytin pheophorbide hydrolase. In specific embodiments, the enzyme comprises a polypeptide sequence as defined in any one of SEQ ID NOs: 1, 2, 4, 6 or 8 to 15, or a functional fragment or variant thereof Preferably the enzyme comprises a polypeptide sequence having at least 75% sequence identity to any one of SEQ ID NOs: 1, 2, 4, 6 or 8 to 15 over at least 50 amino acid residues.

Preferably the process further contacting the seeds with one or more further enzymes selected from cellulases, endoglucanases, cellobiohydrolases, hemicellulases, pectinases, phosphoplipases, lipid acyltransferases, proteases and phytases, e.g. with a phospholipase C or lipid acyltransferase.

In some embodiments, the seeds are selected from soya beans, peanuts, cotton seeds, sunflower seeds and rapeseeds, preferably soya or rapeseed (canola).

In a further aspect, the present invention provides a method for obtaining oil from plant seeds, comprising a) treating the seeds by a process as defined above; b) pressing the treated seeds; and c) recovering oil from the pressed seeds.

In a further aspect, the present invention provides a process for producing a refined plant oil, comprising obtaining a crude oil by a method as defined above, and refining the crude oil to obtain a refined plant oil.

The above process preferably comprises a degumming step comprising addition of an acid to the oil followed by neutralisation with an alkali. Preferably the process does not comprise a step of clay treatment. In one embodiment the process further comprises performing a deodorisation step to produce a deodorized oil and a distillate.

In a further aspect the present invention provides a crude or refined plant oil, or a distillate obtainable by a method or process as defined above.

### BRIEF DESCRIPTION OF DRAWINGS

FIG. 1 shows the reactions involving chlorophyll and derivatives and enzymes used in the present invention.

FIG. 2 shows the amino acid sequence of Arabidopsis thaliana chlorophyllase (SEQ ID NO:1).

FIG. 3 shows the amino acid sequence of Triticum aestivum chlorophyllase (SEQ ID NO:2).

FIG. 4 shows a nucleotide sequence encoding Triticum aestivum chlorophyllase (SEQ ID NO:3).

FIG. 5 shows the amino acid sequence of Chlamydomonas reinhardtii chlorophyllase (SEQ ID NO:4).

FIG. 6 shows a nucleotide sequence encoding Chlamydomonas reinhardtii chlorophyllase (SEQ ID NO:5).

FIG. 7 shows the amino acid sequence of a pheophytin pheophorbide hydrolase (PPH) from Arabidopsis thaliana (SEQ ID NO:6). A chloroplast transit peptide is shown in bold.

FIG. 8 shows the nucleotide sequence of a cDNA from Arabidopsis thaliana encoding pheophytin pheophorbide hydrolase (SEQ ID NO:7). The PPH of SEQ ID NO:6 is encoded by residues 173 to 1627 of SEQ ID NO:7.

FIG. 9 shows the polypeptide sequence of Populus trichocarpa PPH (SEQ ID NO:8).

FIG. 10 shows the polypeptide sequence of Vitis vinifera PPH (SEQ ID NO:9).

FIG. 11 shows the polypeptide sequence of Ricinus communis PPH (SEQ ID NO:10).

FIG. 12 shows the polypeptide sequence of Oryza sativa (japonica cultivar-group) PPH (SEQ ID NO:11).

FIG. 13 shows the polypeptide sequence of Zea mays PPH (SEQ ID NO:12).

FIG. 14 shows the polypeptide sequence of Nicotiana tabacum PPH (SEQ ID NO:13).

FIG. 15 shows the polypeptide sequence of Oryza sativa Japonica Group PPH (SEQ ID NO:14).

FIG. 16 shows (a) the polypeptide sequence of Physcomitrella patens subsp. patens PPH (SEQ ID NO:15)

FIG. 17 shows schematically the fusion of the wheat (Triticum aestivum) chlorophyllase gene to the aprE signal sequence.

FIG. 18 shows schematically the plasmid pBN-TRI_CHL containing the wheat (Triticum aestivum) chlorophyllase gene.

FIG. 19 shows schematically the fusion of the Chlarnydomonas reinhardtii chlorophyllase gene to the aprE signal sequence.

FIG. 20 shows schematically the plasmid pBN-CHL_CHL containing the Chlamydomonas reinhardtii chlorophyllase gene.

FIG. 21 is a diagrammatic representation of an oil refining process according to an embodiment of the present invention.

FIG. 22 shows the amino acid sequence of a mutant Aeromonas salmonicida mature lipid acyltransferase (GCAT) with a mutation of Asn80Asp after undergoing post-translational modification (SEQ ID No. 23)

### DETAILED DESCRIPTION

In one aspect the present invention relates to a process for treating oil-containing seeds, comprising a step of contacting the seeds with an enzyme which is capable of hydrolysing chlorophyll or a chlorophyll derivative. Typically the process is used to reduce the content of chlorophyll and/or chlorophyll derivatives in oil extracted from the seeds.

### Oil-Containing Seeds

By “oil-containing seeds” it is typically meant any oleaginous plant seeds, including beans, grain (including bran), kernels, fruits, nuts and the like. The seeds may be derived from any type of plant, especially higher plants, including angiosperms (monocotyledonous and dicotyledonous plants), as well as gymnosperms.

For example, the National Sustainable Agriculture Information Service lists the following as sources of oil for food, specialty, or industrial uses: almonds, apricot kernels, avocado, beech nut, bilberry, black currant, borage, brazil nut, calendula, caraway seed, cashew nut, castor seed, citrus seed, clove, cocoa, coffee, copra (dried coconut), coriander, corn seed, cotton seed, elderberry, evening primrose, grape seed, groundnut, hazelnut, hemp seed, jojoba, linseed, macadamia nut, mace, melon seed, mustard seed, neem seed, niger seed, nutmeg, palm kernel, passion fruit, pecan, pistachio, poppy seed, pumpkin seed, rape seed, raspberry seed, red pepper, rose hip, rubber seed, safflower seed, sea buckthorn, sesame seed, soybean, spurge, stinging nettle, sunflower seed, tropho plant, tomato seed, or walnut. Also useful herein are seeds and the like derived from various plants whose oil content is of interest for use as fuel, such as “eco-fuel”, biodiesel or the like. Such plants include but are not limited to jatropha (e.g. Jatropha curcas, J. mahafalensis, and cultivars thereof); Elaeis guineensis (e.g. Oil palm), Aleurites fordii (rung oil tree or wood oil tree), Ricinus communis (castor bean tree), Copaifera langsdorfii (diesel tree), and Pongammia pinnata (Honge oil tree, or Pongam tree, and cultivars thereof).

Preferred examples of suitable seeds include soya, canola (rape seed), palm, olive, cottonseed, rice bran, corn, palm kernel, coconut, peanut, sesame or sunflower. The process of the invention can be used in conjunction with methods for extracting and processing essential oils, e.g., those from fruit seed oils, e.g. grapeseed, apricot, borage, etc. The process of the invention can be used in conjunction with methods for extracting and processing high phosphorus oils (e.g. soy bean oil).

Chlorophyll and Chlorophyll Derivatives

By “chlorophyll derivative” it is typically meant compounds which comprise both a porphyrin (chlorin) ring and a phytol group (tail), including magnesium-free phytol-containing derivatives such as pheophytin and pyropheophytin. Chlorophyll and (phytol-containing) chlorophyll derivatives are typically greenish is colour, as a result of the porphyrin (chlorin) ring present in the molecule. Loss of magnesium from the porphyrin ring means that pheophytin and pyropheophytin are more brownish in colour than chlorophyll. Thus the presence of chlorophyll and chlorophyll derivatives in an oil, can give such an oil an undesirable green, greenish or brownish colour. In one embodiment, the present process may be performed in order to remove or reduce the green or brown colouring present in oil extracted from the seeds. Accordingly the present process may be referred to as a bleaching or de-colorizing process.

Enzymes used in the process may hydrolyse chlorophyll and phytol-containing chlorophyll derivatives to cleave the phytol tail from the chlorin ring. Hydrolysis of chlorophyll and chlorophyll derivatives typically results in compounds such as chlorophyllide, pheophorbide and pyropheophorbide which are phytol-free derivatives of chlorophyll. These compounds still contain the colour-bearing porphyrin ring, with chlorophyllide being green and pheophorbide and pyropheophorbide a reddish brown colour. In some embodiments, it may also be desirable to remove these phytol-free derivatives and to reduce the green/red/brown colouring in the extracted oil. Thus in one embodiment of the invention, the process may further comprise a step of removing or reducing the level of phytol-free chlorophyll derivatives in the oil extracted from the seeds. The process may involve bleaching or de-colorizing to remove the green and/or red/brown colouring of the extracted oil.

The chlorophyll or chlorophyll derivative may be either a or b forms. Thus as used herein, the term “chlorophyll” includes chlorophyll a and chlorophyll b. In a similar way both a and b forms are covered when referring to pheophytin, pyropheophytin, chlorophyllide, pheophorbide and pyropheophorbide.

Chlorophyll and Chlorophyll Derivatives in Seeds

The chlorophyll and/or chlorophyll derivatives (e.g. chlorophyll, pheophytin and/or pyropheophytin) may be present in the seeds naturally, as a contaminant, or as an undesired component in a processed product. The chlorophyll and/or chlorophyll derivatives (e.g. chlorophyll, pheophytin and/or pyropheophytin) may be present at any level in the seeds. Typically chlorophyll, pheophytin and/or pyropheophytin may be present as a natural contaminant in seeds at a concentration of 0.001 to 1000 mg/kg (0.001 to 1000 ppm, 10⁻⁷ to 10⁻¹ wt %), based on the total weight of the seeds. In further embodiments, the chlorophyll and/or chlorophyll derivatives may be present in the seeds at a concentration of 0.1 to 100, 0.5 to 50, 1 to 50, 1 to 30 or 1 to 10 mg/kg, based on the total weight of the seeds.

Phytol-free chlorophyll derivatives may also be present in the seeds. For instance, chlorophyllide, pyropheophorbide and/or pyropheophorbide may be present at any level in the seeds. Typically chlorophyllide, pyropheophorbide and/or pyropheophorbide may be present in the seeds, either before or after treatment with an enzyme according to the method of the present invention, at a concentration of 0.001 to 1000 mg/kg (0.001 to 1000 ppm, 10⁻⁷ to 10⁻¹ wt %), based on the total weight of the seeds. In further embodiments, the chlorophyllide, pyropheophorbide and/or pyropheophorbide may be present in the composition at a concentration of 0.1 to 100, 0.5 to 50, 1 to 50, 1 to 30 or 1 to 10 mg/kg, based on the total weight of the composition.

Enzymes Hydrolysing Chlorophyll or a Chlorophyll Derivative

The process of the present invention comprises a step of contacting the seeds with an enzyme which is capable of hydrolysing chlorophyll or a chlorophyll derivative. Typically “hydrolyzing chlorophyll or a chlorophyll derivative” means hydrolysing an ester bond in chlorophyll or a (phytol-containing) chlorophyll derivative, e.g. to cleave a phytol group from the chlorin ring in the chlorophyll or chlorophyll derivative. Thus the enzyme typically has an esterase or hydrolase activity. Preferably the enzyme has esterase or hydrolase activity in both an oil phase and an aqueous phase.

Thus the enzyme may, for example, be a chlorophyllase, pheophytinase or pyropheophytinase. Preferably, the enzyme is capable of hydrolysing at least one, at least two or all three of chlorophyll, pheophytin and pyropheophytin. In a particularly preferred embodiment, the enzyme has chlorophyllase, pheophytinase and pyropheophytinase activity. In further embodiments, two or more enzymes may be used in the method, each enzyme having a different substrate specificity. For instance, the method may comprise the combined use of two or three enzymes selected from a chlorophyllase, a pheophytinase and a pyropheophytinase.

Any polypeptide having an activity that can hydrolyse chlorophyll or a chlorophyll derivative can be used as the enzyme in the process of the invention. By “enzyme” it is intended to encompass any polypeptide having hydrolytic activity on chlorophyll or a chlorophyll derivative, including e.g. enzyme fragments, etc. Any isolated, recombinant or synthetic or chimeric (or a combination of synthetic and recombinant) polypeptide can be used.

Enzyme (Chlorophyllase, Pheophytinase or Pyropheophytinase) Activity Assay

Hydrolytic activity on chlorophyll or a chlorophyll derivative may be detected using any suitable assay technique, for example based on an assay described herein. For example, hydrolytic activity may be detected using fluorescence-based techniques. In one suitable assay, a polypeptide to be tested for hydrolytic activity on chlorophyll or a chlorophyll derivative is incubated in the presence of a substrate, and product or substrate levels are monitored by fluorescence measurement. Suitable substrates include e.g. chlorophyll, pheophytin and/or pyropheophytin. Products which may be detected include chlorophyllide, pheophorbide, pyropheophorbide and/or phytol.

Assay methods for detecting hydrolysis of chlorophyll or a chlorophyll derivative are disclosed in, for example, Ali Khamessan et al. (1994), Journal of Chemical Technology & Biotechnology, 60(1), pages 73-81; Klein and Vishniac (1961), J. Biol. Chem. 236: 2544-2547; and Kiani et al. (2006), Analytical Biochemistry 353: 93-98.

Alternatively, a suitable assay may be based on HPLC detection and quantitation of substrate or product levels following addition of a putative enzyme, e.g. based on the techniques described below. In one embodiment, the assay may be performed as described in Hornero-Mendez et al. (2005), Food Research International 38(8-9): 1067-1072. In another embodiment, the following assay may be used:

170 μl 50 mM HEPES, pH 7.0 is added to 20 μl 0.3 mM chlorophyll, pheophytin or pyropheophytin dissolved in acetone. The enzyme is dissolved in 50 mM HEPES, pH 7.0. 10 μl enzyme solution is added to 190 μl substrate solution to initiate the reaction and incubated at 40° C. for various time periods. The reaction was stopped by addition of 350 μl acetone. Following centrifugation (2 min at 18,000 g) the supernatant was analyzed by HPLC, and the amounts of (i) chlorophyll and chlorophyllide (ii) pheophytin and pheophorbide or (iii) pyropheophytin and pyropheophorbide determined.

In a further embodiment, hydrolytic activity on chlorophyll or a chlorophyll derivative may be determined using a method as described in EP10159327.5.

One unit of enzyme activity is defined as the amount of enzyme which hydrolyzes one micromole of substrate (e.g. chlorophyll, pheophytin or pyropheophytin) per minute at 40° C., e.g. in an assay method as described herein.

In preferred embodiments, the enzyme used in the present process has chlorophyllase, pheophytinase and/or pyropheophytinase activity of at least 1000 U/g, at least 5000 U/g, at least 10000 U/g, or at least 50000 U/g, based on the units of activity per gram of the purified enzyme, e.g. as determined by an assay method described herein.

Chlorophyllases

In one embodiment, the enzyme is capable of hydrolyzing at least chlorophyll. Any polypeptide that catalyses the hydrolysis of a chlorophyll ester bond to yield chlorophyllide and phytol can be used in the process. For example, a chlorophyllase, chlase or chlorophyll chlorophyllido-hydrolyase or polypeptide having a similar activity (e.g., chlorophyll-chlorophyllido hydrolase 1 or chlase 1, or, chlorophyll-chlorophyllido hydrolase 2 or chlase 2, see, e.g. NCBI P59677-1 and P59678, respectively) can be used in the process.

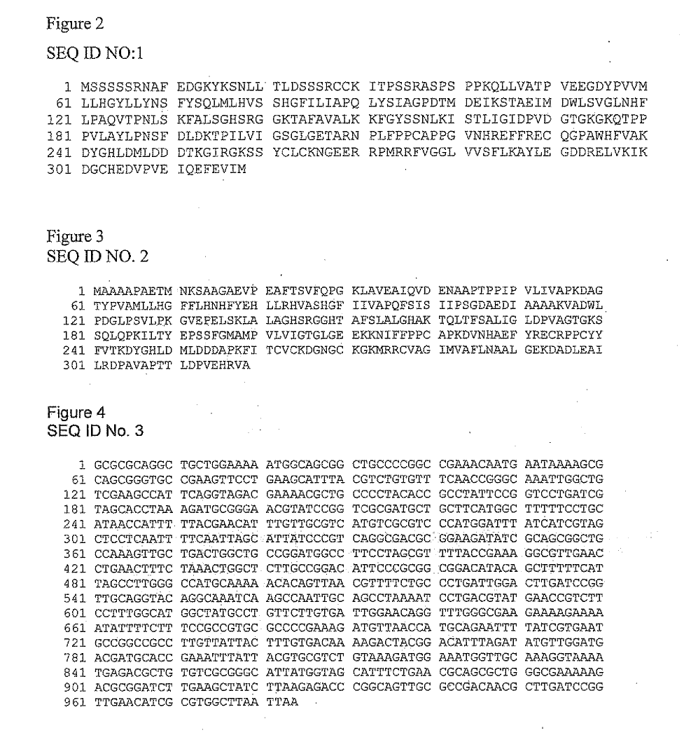

In one embodiment the enzyme is a chlorophyllase classified under the Enzyme Nomenclature classification (E.C. 3.1.1.14). Any isolated, recombinant or synthetic or chimeric (a combination of synthetic and recombinant) polypeptide (e.g., enzyme or catalytic antibody) can be used, see e.g. Marchler-Bauer (2003) Nucleic Acids Res. 31: 383-387. In one aspect, the chlorophyllase may be an enzyme as described in WO 0229022 or WO 2006009676. For example, the Arabidopsis thaliana chlorophyllase can be used as described, e.g. in NCBI entry NM_{—}123753. Thus the chlorophyllase may be a polypeptide comprising the sequence of SEQ ID NO:1 (see FIG. 2). In another embodiment, the chlorophyllase is derived from algae, e.g. from Phaeodactylum tricornutum.

In another embodiment, the chlorophyllase is derived from wheat, e.g. from Triticum spp., especially from Triticum aestivum. For example, the chlorophyllase may be polypeptide comprising the sequence of SEQ ID NO:2 (see FIG. 3), or may be encoded by the nucleotide sequence of SEQ ID NO:3 (see FIG. 4).

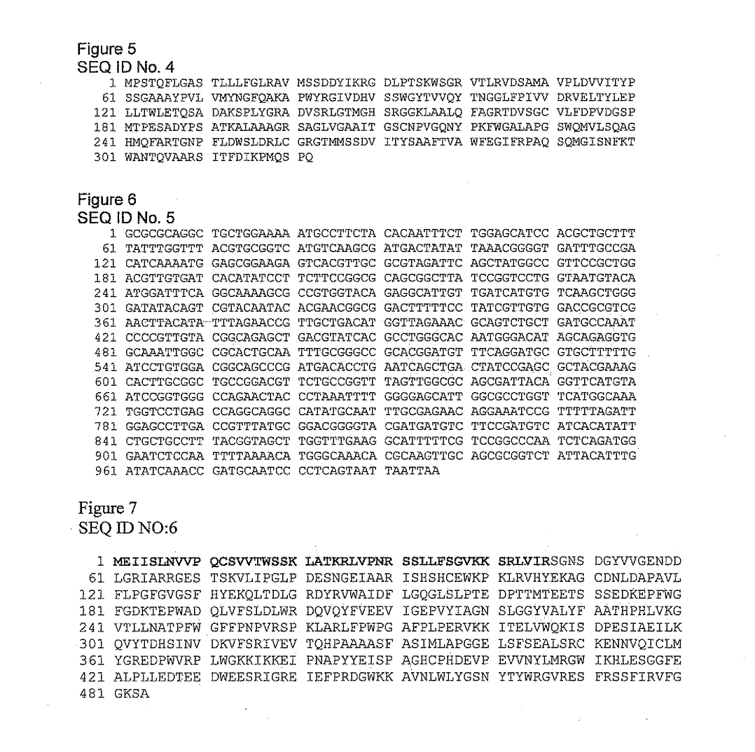

In another embodiment, the chlorophyllase is derived from Chlamydomonas spp., especially from Chlamydomonas reinhardtii. For example, the chlorophyllase may be a polypeptide comprising the sequence of SEQ ID NO:4 (see FIG. 5), or may be encoded by the nucleotide sequence of SEQ ID NO:5 (see FIG. 6).

Pheophytin Pheophorbide Hydrolase

In one embodiment, the enzyme is capable of hydrolyzing pheophytin and pyropheophytin. For example, the enzyme may be pheophytinase or pheophytin pheophorbide hydrolase (PPH), e.g. an enzyme as described in Schelbert et al., The Plant Cell 21:767-785 (2009).

PPH and related enzymes are capable of hydrolyzing pyropheophytin in addition to pheophytin. However PPH is inactive on chlorophyll. As described in Schelbert et al., PPH orthologs are commonly present in eukaryotic photosynthesizing organisms. PPHs represent a defined sub-group of α/β hydrolases which are phylogenetically distinct from chlorophyllases, the two groups being distinguished in terms of sequence homology and substrates.

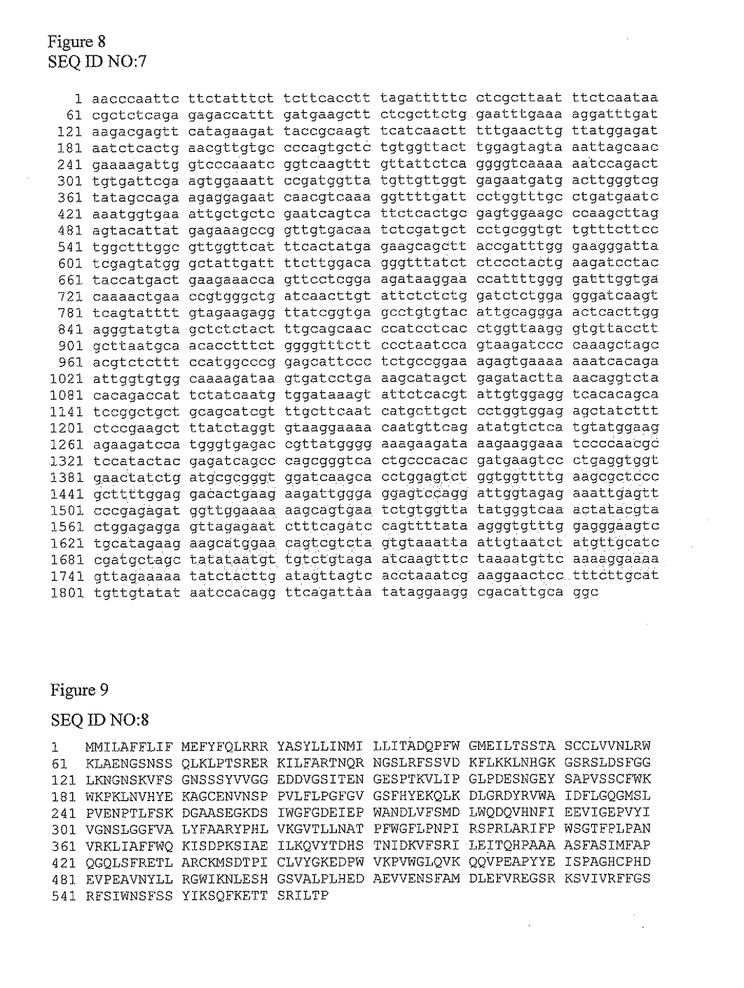

In specific embodiments of the invention, the enzyme may be any known PPH derived from any species or a functional variant or fragment thereof or may be derived from any known PPH enzyme. For example, in one embodiment, the enzyme is a PPH from Arabidopsis thaliana, e.g. a polypeptide comprising the amino acid sequence of SEQ ID NO:6 (see FIG. 7), or a polypeptide encoded by the nucleotide sequence of SEQ ID NO:7 (see FIG. 8, NCBI accession no. NP_{—}196884, GenBank ID No. 15240707), or a functional variant or fragment thereof.

In further embodiments, the enzyme may be a PPH derived from any one of the following species: Arabidopsis thaliana, Populus trichocarpa, Vitis vinifera, Oryza sativa, Zea mays, Nicotiana tabacum, Ostreococcus lucimarinus, Ostreococcus taurii, Physcomitrella patens, Phaeodactylum tricornutum, Chlamydomonas reinhardtii, or Micromonas sp. RCC299. For example, the enzyme may be a polypeptide comprising an amino acid sequence, or encoded by a nucleotide sequence, defined in one of the following database entries shown in Table 1, or a functional fragment or variant thereof:

TABLE 1

| Organism | Accession | Genbank ID |
|---|---|---|
| Arabidopsis thaliana | NP_196884 | 15240707 |
| Populus trichocarpa | XP_002314066 | 224106163 |
| Vitis vinifera | CAO40741 | 157350650 |
| Oryza sativa (japonica) | NP_001057593 | 115467988 |
| Zea mays | ACF87407 | 194706646 |
| Nicotiana tabacum | CAO99125 | 156763846 |
| Ostreococcus lucimarinus | XP_001415589 | 145340970 |
| Ostreococcus tauri | CAL50341 | 116000661 |
| Physcomitrella patens | XP_001761725 | 168018382 |
| Phaeodactylum tricornutum | XP_002181821 | 219122997 |
| Chlamydomonas reinhardtii | XP_001702982 | 159490010 |
| Micromonas sp. RCC299 | ACO62405 | 226516410 |

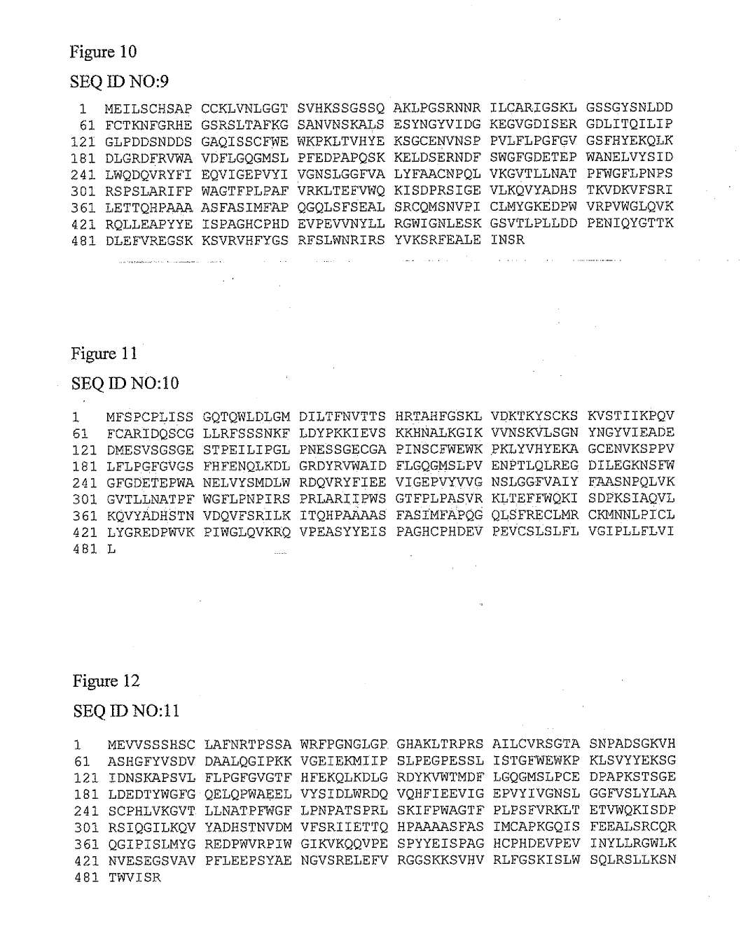

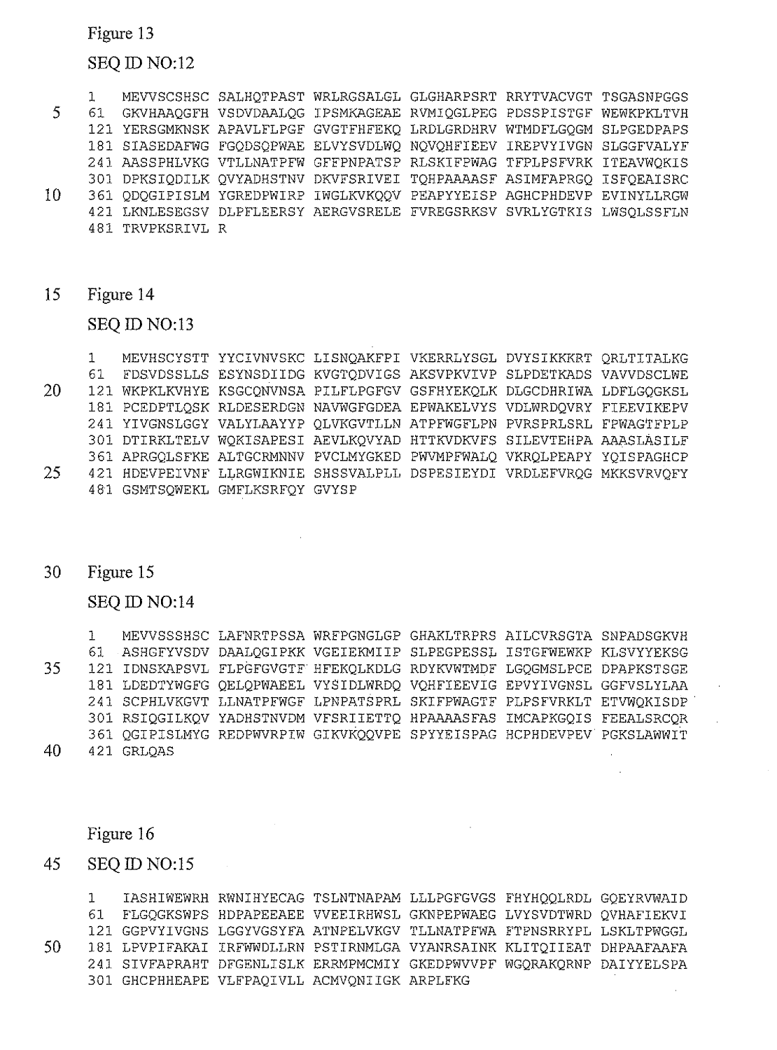

For example, the enzyme may be a polypeptide as defined in any of SEQ ID NO:s 8 to 15 (FIGS. 9 to 16), or a functional fragment or variant thereof.

Variants and Fragments

Functional variants and fragments of known sequences which hydrolyse chlorophyll or a chlorophyll derivative may also be employed in the present invention. By “functional” it is meant that the fragment or variant retains a detectable hydrolytic activity on chlorophyll or a chlorophyll derivative. Typically such variants and fragments show homology to a known chlorophyllase, pheophytinase or pyropheophytinase sequence, e.g. at least about 50%, 60%, 70%, 75%, 80%, 85%, 90%, 95%, 96%, 97%, 98%, 99%, or more sequence identity to a known chlorophyllase, pheophytinase or pyropheophytinase amino acid sequence, e.g. to SEQ ID NO:1 or any one of SEQ ID NOs: 1, 2, 4, 6 or 8 to 15, e.g. over a region of at least about 10, 20, 30, 50, 100, 200, 300, 500, or 1000 or more residues, or over the entire length of the sequence.

The percentage of sequence identity may be determined by analysis with a sequence comparison algorithm or by a visual inspection. In one aspect, the sequence comparison algorithm is a BLAST algorithm, e.g., a BLAST version 2.2.2 algorithm.

Other enzymes having chlorophyllase, pheophytinase and/or pyropheophytinase activity suitable for use in the process may be identified by determining the presence of conserved sequence motifs present e.g. in known chlorophyllase, pheophytinase or pyropheophytinase sequences. For example, conserved sequence motifs found in PPH enzymes include the following: LPGFGVG (SEQ ID NO:16), DFLGQG (SEQ ID NO:17), GNSLGG (SEQ ID NO:18), LVKGVTLLNATPFW (SEQ ID NO:19), HPAA (SEQ ID NO:20), EDPW (SEQ ID NO:21), and SPAGHCPH (SEQ ID NO:22). In some embodiments, an enzyme for use in the present invention may comprise one or more of these sequences. The GNSLGG (SEQ ID NO:18) motif contains an active site serine residue. Polypeptide sequences having suitable activity may be identified by searching genome databases, e.g. the microbiome metagenome database (JGI-DOE, USA), for the presence of these motifs.

Isolation and Production of Enzymes

Enzymes for use in the present invention may be isolated from their natural sources or may be, for example, produced using recombinant DNA techniques. Nucleotide sequences encoding polypeptides having chlorophyllase, pheophytinase and/or pyropheophytinase activity may be isolated or constructed and used to produce the corresponding polypeptides.

For example, a genomic DNA and/or cDNA library may be constructed using chromosomal DNA or messenger RNA from the organism producing the polypeptide. If the amino acid sequence of the polypeptide is known, labeled oligonucleotide probes may be synthesised and used to identify polypeptide-encoding clones from the genomic library prepared from the organism. Alternatively, a labelled oligonucleotide probe containing sequences homologous to another known polypeptide gene could be used to identify polypeptide-encoding clones. In the latter case, hybridisation and washing conditions of lower stringency are used.

Alternatively, polypeptide-encoding clones could be identified by inserting fragments of genomic DNA into an expression vector, such as a plasmid, transforming enzyme-negative bacteria with the resulting genomic DNA library, and then plating the transformed bacteria onto agar containing an enzyme inhibited by the polypeptide, thereby allowing clones expressing the polypeptide to be identified.

In a yet further alternative, the nucleotide sequence encoding the polypeptide may be prepared synthetically by established standard methods, e.g. the phosphoroamidite method described by Beucage S. L. et al (1981) Tetrahedron Letters 22, p 1859-1869, or the method described by Matthes et al (1984) EMBO J. 3, p 801-805. In the phosphoroamidite method, oligonucleotides are synthesised, e.g. in an automatic DNA synthesiser, purified, annealed, ligated and cloned in appropriate vectors.

The nucleotide sequence may be of mixed genomic and synthetic origin, mixed synthetic and cDNA origin, or mixed genomic and cDNA origin, prepared by ligating fragments of synthetic, genomic or cDNA origin (as appropriate) in accordance with standard techniques. Each ligated fragment corresponds to various parts of the entire nucleotide sequence. The DNA sequence may also be prepared by polymerase chain reaction (PCR) using specific primers, for instance as described in U.S. Pat. No. 4,683,202 or in Saiki R K et al (Science (1988) 239, pp 487-491).

The term “nucleotide sequence” as used herein refers to an oligonucleotide sequence or polynucleotide sequence, and variant, homologues, fragments and derivatives thereof (such as portions thereof). The nucleotide sequence may be of genomic or synthetic or recombinant origin, which may be double-stranded or single-stranded whether representing the sense or antisense strand.

Typically, the nucleotide sequence encoding a polypeptide having chlorophyllase, pheophytinase and/or pyropheophytinase activity is prepared using recombinant DNA techniques. However, in an alternative embodiment of the invention, the nucleotide sequence could be synthesised, in whole or in part, using chemical methods well known in the art (see Caruthers M H et al (1980) Nuc Acids Res Symp Ser 215-23 and Horn T et al (1980) Nuc Acids Res Symp Ser 225-232).

Modification of Enzyme Sequences

Once an enzyme-encoding nucleotide sequence has been isolated, or a putative enzyme-encoding nucleotide sequence has been identified, it may be desirable to modify the selected nucleotide sequence, for example it may be desirable to mutate the sequence in order to prepare an enzyme in accordance with the present invention.

Mutations may be introduced using synthetic oligonucleotides. These oligonucleotides contain nucleotide sequences flanking the desired mutation sites. A suitable method is disclosed in Morinaga et al (Biotechnology (1984) 2, p 646-649). Another method of introducing mutations into enzyme-encoding nucleotide sequences is described in Nelson and Long (Analytical Biochemistry (1989), 180, p 147-151).

Instead of site directed mutagenesis, such as described above, one can introduce mutations randomly for instance using a commercial kit such as the GeneMorph PCR mutagenesis kit from Stratagene, or the Diversify PCR random mutagenesis kit from Clontech. EP 0 583 265 refers to methods of optimising PCR based mutagenesis, which can also be combined with the use of mutagenic DNA analogues such as those described in EP 0 866 796. Error prone PCR technologies are suitable for the production of variants of enzymes which hydrolyse chlorophyll and/or chlorophyll derivatives with preferred characteristics. WO0206457 refers to molecular evolution of lipases.

A third method to obtain novel sequences is to fragment non-identical nucleotide sequences, either by using any number of restriction enzymes or an enzyme such as Dnase I, and reassembling full nucleotide sequences coding for functional proteins. Alternatively one can use one or multiple non-identical nucleotide sequences and introduce mutations during the reassembly of the full nucleotide sequence. DNA shuffling and family shuffling technologies are suitable for the production of variants of enzymes with preferred characteristics. Suitable methods for performing ‘shuffling’ can be found in EP0752008, EP1138763, EP1103606. Shuffling can also be combined with other forms of DNA mutagenesis as described in U.S. Pat. No. 6,180,406 and WO 01/34835.

Thus, it is possible to produce numerous site directed or random mutations into a nucleotide sequence, either in vivo or in vitro, and to subsequently screen for improved functionality of the encoded polypeptide by various means. Using in silico and exo mediated recombination methods (see WO 00/58517, U.S. Pat. No. 6,344,328, U.S. Pat. No. 6,361,974), for example, molecular evolution can be performed where the variant produced retains very low homology to known enzymes or proteins. Such variants thereby obtained may have significant structural analogy to known chlorophyllase, pheophytinase or pyropheophytinase enzymes, but have very low amino acid sequence homology.

As a non-limiting example, in addition, mutations or natural variants of a polynucleotide sequence can be recombined with either the wild type or other mutations or natural variants to produce new variants. Such new variants can also be screened for improved functionality of the encoded polypeptide.

The application of the above-mentioned and similar molecular evolution methods allows the identification and selection of variants of the enzymes of the present invention which have preferred characteristics without any prior knowledge of protein structure or function, and allows the production of non-predictable but beneficial mutations or variants. There are numerous examples of the application of molecular evolution in the art for the optimisation or alteration of enzyme activity, such examples include, but are not limited to one or more of the following: optimised expression and/or activity in a host cell or in vitro, increased enzymatic activity, altered substrate and/or product specificity, increased or decreased enzymatic or structural stability, altered enzymatic activity/specificity in preferred environmental conditions, e.g. temperature, pH, substrate.

As will be apparent to a person skilled in the art, using molecular evolution tools an enzyme may be altered to improve the functionality of the enzyme. Suitably, a nucleotide sequence encoding an enzyme (e.g. a chlorophyllase, pheophytinase and/or pyropheophytinase) used in the invention may encode a variant enzyme, i.e. the variant enzyme may contain at least one amino acid substitution, deletion or addition, when compared to a parental enzyme. Variant enzymes retain at least 1%, 2%, 3%, 5%, 10%, 15%, 20%, 30%, 40%, 50%, 60%, 70%, 80%, 90%, 95%, 97%, or 99% identity with the parent enzyme. Suitable parent enzymes may include any enzyme with hydrolytic activity on chlorophyll and/or a chlorophyll derivative.

Polypeptide Sequences

The present invention also encompasses the use of amino acid sequences encoded by a nucleotide sequence which encodes a pyropheophytinase for use in any one of the methods and/or uses of the present invention.

As used herein, the term “amino acid sequence” is synonymous with the term “polypeptide” and/or the term “protein”. In some instances, the term “amino acid sequence” is synonymous with the term “peptide”. The amino acid sequence may be preparedlisolated from a suitable source, or it may be made synthetically or it may be prepared by use of recombinant DNA techniques. Suitably, the amino acid sequences may be obtained from the isolated polypeptides taught herein by standard techniques.

One suitable method for determining amino acid sequences from isolated polypeptides is as follows. Purified polypeptide may be freeze-dried and 100 μg of the freeze-dried material may be dissolved in 50 μl of a mixture of 8 M urea and 0.4 M ammonium hydrogen carbonate, pH 8.4. The dissolved protein may be denatured and reduced for 15 minutes at 50° C. following overlay with nitrogen and addition of 5 μl of 45 mM dithiothreitol. After cooling to room temperature, 5 μl of 100 mM iodoacetamide may be added for the cysteine residues to be derivatized for 15 minutes at room temperature in the dark under nitrogen.

135 μl of water and 5 μg of endoproteinase Lys-C in 5 μl of water may be added to the above reaction mixture and the digestion may be carried out at 37° C. under nitrogen for 24 hours. The resulting peptides may be separated by reverse phase HPLC on a VYDAC C18 column (0.46×15 cm; 10 μm; The Separation Group, California, USA) using solvent A: 0.1% TFA in water and solvent B: 0.1% TFA in acetonitrile. Selected peptides may be re-chromatographed on a Develosil C18 column using the same solvent system, prior to N-terminal sequencing. Sequencing may be done using an Applied Biosystems 476A sequencer using pulsed liquid fast cycles according to the manufacturer's instructions (Applied Biosystems, California, USA).

Sequence Comparison

Here, the term “homologue” means an entity having a certain homology with the subject amino acid sequences and the subject nucleotide sequences. Here, the teem “homology” can be equated with “identity”. The homologous amino acid sequence and/or nucleotide sequence should provide and/or encode a polypeptide which retains the functional activity and/or enhances the activity of the enzyme.

In the present context, a homologous sequence is taken to include an amino acid sequence which may be at least 75, 85 or 90% identical, preferably at least 95 or 98% identical to the subject sequence. Typically, the homologues will comprise the same active sites etc. as the subject amino acid sequence. Although homology can also be considered in terms of similarity (Le. amino acid residues having similar chemical properties/functions), in the context of the present invention it is preferred to express homology in terms of sequence identity.

In the present context, a homologous sequence is taken to include a nucleotide sequence which may be at least 75, 85 or 90% identical, preferably at least 95 or 98% identical to a nucleotide sequence encoding a polypeptide of the present invention (the subject sequence). Typically, the homologues will comprise the same sequences that code for the active sites etc. as the subject sequence. Although homology can also be considered in terms of similarity (i.e. amino acid residues having similar chemical properties/functions), in the context of the present invention it is preferred to express homology in terms of sequence identity.

Homology comparisons can be conducted by eye, or more usually, with the aid of readily available sequence comparison programs. These commercially available computer programs can calculate % homology between two or more sequences. % homology may be calculated over contiguous sequences, i.e. one sequence is aligned with the other sequence and each amino acid in one sequence is directly compared with the corresponding amino acid in the other sequence, one residue at a time. This is called an “ungapped” alignment. Typically, such ungapped alignments are performed only over a relatively short number of residues.

Although this is a very simple and consistent method, it fails to take into consideration that, for example, in an otherwise identical pair of sequences, one insertion or deletion will cause the following amino acid residues to be put out of alignment, thus potentially resulting in a large reduction in % homology when a global alignment is performed. Consequently, most sequence comparison methods are designed to produce optimal alignments that take into consideration possible insertions and deletions without penalising unduly the overall homology score. This is achieved by inserting “gaps” in the sequence alignment to try to maximise local homology.

However, these more complex methods assign “gap penalties” to each gap that occurs in the alignment so that, for the same number of identical amino acids, a sequence alignment with as few gaps as possible—reflecting higher relatedness between the two compared sequences—will achieve a higher score than one with many gaps. “Affine gap costs” are typically used that charge a relatively high cost for the existence of a gap and a smaller penalty for each subsequent residue in the gap. This is the most commonly used gap scoring system. High gap penalties will of course produce optimised alignments with fewer gaps. Most alignment programs allow the gap penalties to be modified. However, it is preferred to use the default values when using such software for sequence comparisons.

Calculation of maximum % homology therefore firstly requires the production of an optimal alignment, taking into consideration gap penalties. A suitable computer program for carrying out such an alignment is the Vector NTI Advance™ 11 (Invitrogen Corp.). Examples of other software that can perform sequence comparisons include, but are not limited to, the BLAST package (see Ausubel et al 1999 Short Protocols in Molecular Biology, 4th Ed—Chapter 18), and FASTA (Altschul et al 1990 J. Mol. Biol. 403-410). Both BLAST and FASTA are available for offline and online searching (see Ausubel et al 1999, pages 7-58 to 7-60). However, for some applications, it is preferred to use the Vector NTI Advance™ 11 program. A new tool, called BLAST 2 Sequences is also available for comparing protein and nucleotide sequence (see FEMS Microbiol Lett 1999 174(2): 247-50; and FEMS Microbiol Lett 1999 177(1): 187-8.).

Although the final % homology can be measured in terms of identity, the alignment process itself is typically not based on an all-or-nothing pair comparison. Instead, a scaled similarity score matrix is generally used that assigns scores to each pairwise comparison based on chemical similarity or evolutionary distance. An example of such a matrix commonly used is the BLOSUM62 matrix—the default matrix for the BLAST suite of programs. Vector NTI programs generally use either the public default values or a custom symbol comparison table if supplied (see user manual for further details). For some applications, it is preferred to use the default values for the Vector NTI Advance™ 11 package.

Alternatively, percentage homologies may be calculated using the multiple alignment feature in Vector NTI Advance™ 11 (Invitrogen Corp.), based on an algorithm, analogous to CLUSTAL (Higgins D G & Sharp P M (1988), Gene 73(1), 237-244). Once the software has produced an optimal alignment, it is possible to calculate % homology, preferably % sequence identity. The software typically does this as part of the sequence comparison and generates a numerical result.

Should Gap Penalties be used when determining sequence identity, then preferably the default parameters for the programme are used for pairwise alignment. For example, the following parameters are the current default parameters for pairwise alignment for BLAST 2:

| | | |
|---|---|---|
| FOR BLAST2 | DNA | PROTEIN |
| EXPECT THRESHOLD | 10 | 10 |
| WORD SIZE | 11 | 3 |
| SCORING PARAMETERS | | |
| Match/Mismatch Scores | 2, −3 | n/a |
| Matrix | n/a | BLOSUM62 |
| Gap Costs | Existence: 5 | Existence: 11 |
| | Extension: 2 | Extension: 1 |

In one embodiment, preferably the sequence identity for the nucleotide sequences and/or amino acid sequences may be determined using BLAST2 (blastn) with the scoring parameters set as defined above.

For the purposes of the present invention, the degree of identity is based on the number of sequence elements which are the same. The degree of identity in accordance with the present invention for amino acid sequences may be suitably determined by means of computer programs known in the art such as Vector NTI Advance™ 11 (Invitrogen Corp.). For pairwise alignment the scoring parameters used are preferably BLOSUM62 with Gap existence penalty of 11 and Gap extension penalty of 1.

Suitably, the degree of identity with regard to a nucleotide sequence is determined over at least 20 contiguous nucleotides, preferably over at least 30 contiguous nucleotides, preferably over at least 40 contiguous nucleotides, preferably over at least 50 contiguous nucleotides, preferably over at least 60 contiguous nucleotides, preferably over at least 100 contiguous nucleotides. Suitably, the degree of identity with regard to a nucleotide sequence may be determined over the whole sequence.

Amino Acid Mutations

The sequences may also have deletions, insertions or substitutions of amino acid residues which produce a silent change and result in a functionally equivalent substance. Deliberate amino acid substitutions may be made on the basis of similarity in polarity, charge, solubility, hydrophobicity, hydrophilicity, and/or the amphipathic nature of the residues as long as the secondary binding activity of the substance is retained. For example, negatively charged amino acids include aspartic acid and glutamic acid; positively charged amino acids include lysine and arginine; and amino acids with uncharged polar head groups having similar hydrophilicity values include leucine, isoleucine, valine, glycine, alanine, asparagine, glutamine, serine, threonine, phenylalanine, and tyrosine.

Conservative substitutions may be made, for example according to the Table below. Amino acids in the same block in the second column and preferably in the same line in the third column may be substituted for each other:

| | | |
|---|---|---|
| ALIPHATIC | Non-polar | G A P |
| | | I L V |
| | Polar - uncharged | C S T M |
| | | N Q |
| | Polar - charged | D E |
| | | K R |
| AROMATIC | | H F W Y |

The present invention also encompasses homologous substitution (substitution and replacement are both used herein to mean the interchange of an existing amino acid residue, with an alternative residue) that may occur i.e. like-for-like substitution such as basic for basic, acidic for acidic, polar for polar etc. Non-homologous substitution may also occur i.e. from one class of residue to another or alternatively involving the inclusion of unnatural amino acids such as ornithine (hereinafter referred to as Z), diaminobutyric acid ornithine (hereinafter referred to as B), norleucine ornithine (hereinafter referred to as O), pyriylalanine, thienylalanine, naphthylalanine and phenylglycine. Replacements may also be made by unnatural amino acids.

Variant amino acid sequences may include suitable spacer groups that may be inserted between any two amino acid residues of the sequence including alkyl groups such as methyl, ethyl or propyl groups in addition to amino acid spacers such as glycine or β-alanine residues. A further form of variation, involves the presence of one or more amino acid residues in peptoid form, will be well understood by those skilled in the art. For the avoidance of doubt, “the peptoid form” is used to refer to variant amino acid residues wherein the α-carbon substituent group is on the residue's nitrogen atom rather than the α-carbon. Processes for preparing peptides in the peptoid form are known in the art, for example Simon R J et al., PNAS (1992) 89(20), 9367-9371 and Horwell D C, Trends Biotechnol. (1995) 13(4), 132-134.

Nucleotide Sequences

Nucleotide sequences for use in the present invention or encoding a polypeptide having the specific properties defined herein may include within them synthetic or modified nucleotides. A number of different types of modification to oligonucleotides are known in the art. These include methylphosphonate and phosphorothioate backbones and/or the addition of acridine or polylysine chains at the 3′ and/or 5′ ends of the molecule. For the purposes of the present invention, it is to be understood that the nucleotide sequences described herein may be modified by any method available in the art. Such modifications may be carried out in order to enhance the in vivo activity or life span of nucleotide sequences.

The present invention also encompasses the use of nucleotide sequences that are complementary to the sequences discussed herein, or any derivative, fragment or derivative thereof. If the sequence is complementary to a fragment thereof then that sequence can be used as a probe to identify similar coding sequences in other organisms etc.

Polynucleotides which are not 100% homologous to the sequences of the present invention but fall within the scope of the invention can be obtained in a number of ways. Other variants of the sequences described herein may be obtained for example by probing DNA libraries made from a range of individuals, for example individuals from different populations. In addition, other viral/bacterial, or cellular homologues particularly cellular homologues found in plant cells, may be obtained and such homologues and fragments thereof in general will be capable of selectively hybridising to the sequences shown in the sequence listing herein. Such sequences may be obtained by probing cDNA libraries made from or genomic DNA libraries from other plant species, and probing such libraries with probes comprising all or part of any one of the sequences in the attached sequence listings under conditions of medium to high stringency. Similar considerations apply to obtaining species homologues and allelic variants of the polypeptide or nucleotide sequences of the invention.

Variants and strain/species homologues may also be obtained using degenerate PCR which will use primers designed to target sequences within the variants and homologues encoding conserved amino acid sequences within the sequences of the present invention. Conserved sequences can be predicted, for example, by aligning the amino acid sequences from several variants/homologues. Sequence alignments can be performed using computer software known in the art. For example the GCG Wisconsin PileUp program is widely used.

The primers used in degenerate PCR will contain one or more degenerate positions and will be used at stringency conditions lower than those used for cloning sequences with single sequence primers against known sequences.

Alternatively, such polynucleotides may be obtained by site directed mutagenesis of characterised sequences. This may be useful where for example silent codon sequence changes are required to optimise codon preferences for a particular host cell in which the polynucleotide sequences are being expressed. Other sequence changes may be desired in order to introduce restriction polypeptide recognition sites, or to alter the property or function of the polypeptides encoded by the polynucleotides.

Polynucleotides (nucleotide sequences) of the invention may be used to produce a primer, e.g. a PCR primer, a primer for an alternative amplification reaction, a probe e.g. labelled with a revealing label by conventional means using radioactive or non-radioactive labels, or the polynucleotides may be cloned into vectors. Such primers, probes and other fragments will be at least 15, preferably at least 20, for example at least 25, 30 or 40 nucleotides in length, and are also encompassed by the term polynucleotides of the invention as used herein.

Polynucleotides such as DNA polynucleotides and probes according to the invention may be produced recombinantly, synthetically, or by any means available to those of skill in the art. They may also be cloned by standard techniques.

In general, primers will be produced by synthetic means, involving a stepwise manufacture of the desired nucleic acid sequence one nucleotide at a time. Techniques for accomplishing this using automated techniques are readily available in the art.

Longer polynucleotides will generally be produced using recombinant means, for example using a PCR (polymerase chain reaction) cloning techniques. This will involve making a pair of primers (e.g. of about 15 to 30 nucleotides) flanking a region of the pyropheophytinase sequence which it is desired to clone, bringing the primers into contact with mRNA or cDNA obtained from a plant cell, performing a polymerase chain reaction under conditions which bring about amplification of the desired region, isolating the amplified fragment (e.g. by purifying the reaction mixture on an agarose gel) and recovering the amplified DNA. The primers may be designed to contain suitable restriction enzyme recognition sites so that the amplified DNA can be cloned into a suitable cloning vector.

Preparation of Seeds

In some embodiments the enzyme may be contacted directly with untreated oilseeds. Alternatively the seeds may first be subjected to various treatments such as cleaning, conditioning and/or flaking, e.g. as described in Bailey's Industrial Oil and Fat Products (2005), 6^{th} edition, Ed. by Fereidoon Shahidi, John Wiley & Sons, Chapter 2. In one embodiment, the seeds are subjected to a mechanical and/or chemical treatment step which increases the surface area of the seeds and/or facilitates penetration of the enzyme into the seeds, in order to increase the rate of hydrolysis of chlorophyll and chlorophyll metabolites. For instance, in some embodiments the seeds may be crushed, ground, peeled or flaked before contacting with the enzyme. Suitable methods are well known in the art for preparing seeds in such a manner.

In one embodiment, the enzyme is contacted with seed flakes. Seeds may be flaked, for example, using smooth-surface rolling mills in one or more stages. The flake thickness may be about 0.1 to 1 mm, preferably 0.1 to 0.5 mm, more preferably 0.2 to 0.4 mm (e.g. about 0.3 mm). In an embodiment of a single stage flaking process, flakes of e.g. rapeseed having a thickness of about 0.3 mm may be produced in a single step. In one embodiment of a two-stage method, suitable for use with e.g. rapeseed, a flake thickness of about 0.4-0.7 mm is produced by a first set of rolls, and then flakes of 0.2-0.3 mm thickness are produced in a second stage. Flaking ruptures the cell walls, which not only releases some of the oil from the seeds but increases penetration of the enzyme, thereby facilitating hydrolysis of chlorophyll and its metabolites.

Contacting the Enzyme with the Seeds

The enzyme may be applied to the seeds, e.g. whole, flaked, peeled, ground or crushed seeds, in any suitable manner. Typically the enzyme is applied to the seeds in the form of an aqueous solution. In one embodiment, the enzyme may be applied by spraying the seeds with an aqueous solution comprising the enzyme. Apparatus suitable for spraying liquids is well-known in the art. Exemplary equipment includes hand and electric pump-driven sprayers.

In one embodiment, the aqueous enzyme solution may be recovered from the culture supernatant of a microorganism which produces the enzyme. A suitable purified enzyme solution may be obtained using known purification techniques such as filtration and chromatography. For instance, one purification method might involve separating the bio-mass from the culture liquid, and concentrating the obtained solution by ultra-filtration and disinfection filtration.

Enzymes used in the methods of the invention can be formulated or modified, e.g., chemically modified, to enhance oil solubility, stability, activity or for immobilization. For example, enzymes used in the methods of the invention can be formulated to be amphipathic or more lipophilic. For example, the enzyme may be formulated with surfactants in order to increase the activity of the enzyme. Surfactants such as sorbitan esters, citric acid esters, glycerol or polyglycerol esters, or polyoxyethylene esters may be used. In other embodiments, enzymes used in the methods of the invention can be encapsulated, e.g., in liposomes or gels, e.g., alginate hydrogels or alginate beads or equivalents. Enzymes used in the methods of the invention can be formulated in micellar systems, e.g., a ternary micellar (TMS) or reverse micellar system (RMS) medium. Enzymes used in the methods of the invention can be formulated as described in Yi (2002) J. of Molecular Catalysis B: Enzymatic, Vol. 19, pgs 319-325.

The enzyme may be applied to the seeds in any suitable amount. For example, the solution may comprise the enzyme at a concentration of about 0.001 to 10 U/g, preferably 0.01 to 1 U/g, e.g. 0.01 to 0.1 U/g, based on the total weight of the solution. One unit is defined as the amount of enzyme which hydrolyses 1 μmol of substrate (e.g. chlorophyll, pheophytin and/or pyropheophytin) per minute at 40° C., e.g. under assay conditions as described in J. Biol. Chem. (1961) 236: 2544-2547.

Further Enzyme Activities

In some embodiments, one or more further enzymes may be applied to the seeds in addition to the enzyme which hydrolyzes chlorophyll or a derivative thereof. A number of enzymes may be used in order to digest plant seed material and improve the yield oil from the seeds (see e.g. WO1991/013956, EP0113165, WO2008/088489 and CA2673926). Such further enzymatic treatments are useful for weakening and the partially decomposing cell walls (primary and secondary cell wall) as well as the destruction of the membrane envelope surrounding the oil. This facilitates oil release from the seeds and its subsequent recovery.

For instance, the aqueous solution may further comprise one or more cellulolytic, hemicellulolytic, lipolytic, pectinolytic and/or proteolytic enzymes, e.g. as described in CA2673926. In one embodiment, the solution further comprises one or more cellulases, endoglucanases, cellobiohydrolases, hemicellulases, pectinases, phosphoplipases, proteases and/or phytases. Such enzymes may be obtained from natural or recombinant sources. These enzymes may be used individually or in combination, depending of the composition of the seeds, e.g., for protein-rich seeds such as soy beans a protease is preferably used. Such further enzyme activities may be present in differing amounts in commercially available products, e.g. Rohalase®OS, a mixture comprising cellulase, beta-glucanase and xylanase activities available from AB Enzymes, Damistadt, Germany.

Hemicellulolytic and pectinolytic enzymes are preferably used for seeds that contain an increased amount of these storage substances in the cell walls, typically where cellulases alone would not cause sufficient loosening or perforation of the cell wall. Pectinases are particularly useful for degrading the protopectine of the middle lamellae, which results in improved paste formation for pressing and facilitates oil release. Galactomannanases are preferred for use with, for example, soy beans. Thermostable forms of such enzymes may be used in some embodiments.

In some embodiments, the further enzyme(s) may comprise a phospholipase or a protease. Such enzymes are useful for destabilizing an oil/water emulsion, which may be obtained by aqueous solvent extraction of lipid from an oilseed, e.g. as described in WO2008/088489. Enzymes combinations or mixtures that include one or more of these activities are also suitable. Such enzyme activities from any source including animal, plant, or microbial may be used. In one embodiment, the enzyme activity comprises a phospholipase activity from a mammalian (e.g. porcine) pancreas, Streptomyces violaceoruber, Aspergillus oryzae, or Aspergillus niger. Use of a phospholipase may reduce the phosphatide content of the oil obtained from the seeds, which reduces the need for degumming procedures at a later stage of the oil processing method. However, where a phospholipase in used in the present invention, it is preferred that the chlorophyllase or related enzyme is contacted with the seeds before or at the same time as (i.e. not after) contacting with the phospholipase.

Phospholipases which may be used include, but are not limited to, phospholipases A (including A1 and A2), B (also sometimes referred to as lysophospholipase), C, and D. Phospholipases are a class of enzymes that hydrolyze phospholipids, such as phosphatidylcholine or phosphatidylethanolamine. Within the phospholipase class of enzymes are five major subclasses, A1, A2, B, C, and D phospholipases. A1 phospholipases (E.C.3.1.1.32) preferentially hydrolyze the sn1 ester bonds of phospholipids, such as phosphatidylcholine or phosphatidylethanolamine, to yield 1-lysophospholipids plus carboxylic acids. Typically, A1 phospholipases require calcium as a cofactor. A1 phospholipases generally exhibit broader specificity than A2 phospholipases.

A2 phospholipases (E.C.3.1.1.4) preferentially hydrolyze the sn2 ester bonds of phospholipids, such as phosphatidylcholine or phosphatidylethanolamine, to yield 2-lysophospholipids plus carboxylic acids. In addition to phospholipids, A2 phospholipases show some specificity for hydrolysis of choline derivatives and phosphatides. Typically, A2 phospholipases require calcium as a cofactor.

B phospholipases (E.C.3.1.1.5) are also known as lysophospholipases. They preferentially hydrolyze the sn1 ester bonds of 2-lysophospholipids to yield glycerophosphatides plus carboxylic acids. B phospholipases will also hydrolyze the sn2 ester bonds of 1-lysophospholipids.

C phospholipases (E.C.3.1.4.3) preferentially hydrolyze the phosphate bonds of phospholipids, such as phosphatidylcholine or phosphatidylethanolamine, to yield the corresponding diacylglycerols and choline phosphates. In addition to hydrolysis of phospholipids, C phospholipases will also act on lysophospholipids. Polypeptides having phospholipase C activity which are may be used in a degumming step are disclosed, for example, in WO2008143679, WO2007092314, WO2007055735, WO2006009676 and WO03089620.

D phospholipases (E.C.3.1.4.4) preferentially hydrolyze the phosphate bond of phospholipids such as phosphatidylcholine or phosphatidylethanolamine to yield the corresponding phosphatidic acids and choline. In addition to hydrolysis of phospholipids, D phospholipases will also act on lysophospholipids. Phospholipases can be used individually or in combination or mixtures of one or more activities of the same or different E.C. classifications, and from the same or different sources. Crude or partially purified enzyme preparations containing one or more phospholipase activities are suitable for use in some embodiments herein. Commercial sources of phospholipases are also suitable for use herein. For example, Genencor (Rochester, N.Y.) offers LysoMax(®) and G-ZYME(®) G999 phospholipases, from bacterial and fungal sources, respectively. Phospholipase C is available commercially, for example, from Sigma (St. Louis, Mo.).

In preferred embodiments of the present invention which employ a phospholipase, preferably the phospholipase does not produce lysophospholipids. It is particularly preferred that the phospholipase does not produce lysophospholipids where the chlorophyllase is contacted with the seeds at the same time as the phospholipase. Preferably the phospholipase is phospholipase C, e.g. Purifine®, available from Verenium Corporation, Cambridge, Mass.

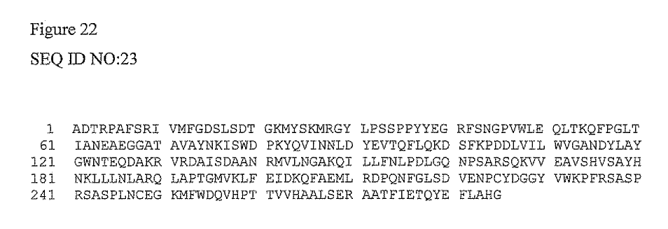

In another embodiment, the further enzyme comprises a lipid acyltransferase, e.g. as described in WO 2006/008508, WO 2004/064537, WO 2004/064987 or WO 2009/024736. Any enzyme having acyltransferase activity (generally classified as E.C.2.3.1) may be used, particularly enzymes comprising the amino acid sequence motif GDSX, wherein X is one or more of the following amino acid residues: L, A, V, I, F, Y, H, Q, T, N, M or S. In one embodiment, acyltransferase is a mutant Aeromonas salmonicida mature lipid acyltransferase (GCAT) with a mutation of Asn80Asp, e.g. an acyltransferase comprising the amino acid sequence of SEQ ID NO:23 after undergoing post-translational modification (see FIG. 22), or an enzyme having at least 80% sequence identity thereto. Preferably the lipid acyl transferase is LysoMax Oil® available from Danisco A/S, Denmark.

Suitable proteases may be obtained, for example, from microbial sources including B. amyloliquifaciens, B. subtilis, B. lichenformis, A. niger or A. oryzae. In one embodiment, the protease activity comprises an endopeptidase. Metalloproteases, whether exo- or endo-proteases, may also be used. Many proteases are available commercially, e.g. Fungal Protease 500,000, Protex 6L protease and Fungal Protease Concentrate available from Genencor (Rochester, N.Y.).

Reaction Conditions

After the aqueous solution comprising the enzyme (and optionally further enzymes) is sprayed onto the seeds, the water content of the seeds will increase. The water content may vary from, for example, 1 to 40% by weight following addition of the enzyme. However, it is preferred that a relatively low amount of water is added, e.g. by spraying. The water applied by spraying the enzyme solution onto the seeds typically increases the natural water content of the seeds (e.g. 4-8% w/w) only by about 0.1 to 2% (w/w), based on the mass of the seed, e.g. as described in CA2673926. After incubation with the enzyme(s), the prepared seed may then be directly pressed and the oil recovered. The pressing procedure is typically improved by a relatively low water content following spraying with the enzyme solution.

At higher temperatures pheophytin is decomposed to pyropheophytin, which is generally less preferred because some chlorophyllases are less active on pyropheophytin compared to pheophytin. In addition, the chlorophyllase degradation product of pyropheophytin, pyropheophorbide, is less water soluble compared to pheophorbide and thus more difficult to remove from the oil afterwards. The enzymatic reaction rate is increased at higher temperatures but it is favourable to keep the conversion of pheophytin to pyropheophytin to a minimum.

In view of the above, in particularly preferred embodiments the seeds are incubated with the enzyme at below about 80° C., preferably below about 70° C., preferably at about 68° C. or below, preferably at about 65° C. or below, in order to reduce the amount of conversion to pyropheophytin. However, in order to keep a good reaction rate it is preferred to keep the temperature of the seeds as high as possible during incubation with the enzyme. It is also preferred to incubate the seeds at a temperature which is high enough to inactivate endogenous lipases. Accordingly, preferably the seeds are incubated with the enzyme between about 5° C. to and about 80° C., more preferably between 10° C. to about 80° C., more preferably between about 15° C. to about 75° C., more preferably between about 20° C. to about 70° C., more preferably between about 30° C. to about 60° C., more preferably between about 40° C. to about 50° C.

Preferably the temperature of the seeds is at the desired reaction temperature when the enzyme is admixed therewith. The seeds may be heated and/or cooled to the desired temperature before and/or during enzyme addition.

Suitably the reaction time (i.e. the time period in which the enzyme is incubated with the seeds), preferably with agitation, is for a sufficient period of time to allow hydrolysis of chlorophyll and chlorophyll derivatives, e.g. to faun phytol and chlorophyllide, pheophorbide and/or pyropheophorbide. For example, the reaction time may be at least about 1 minute, more preferable at least about 5 minutes, more preferably at least about 10 minutes. In some embodiments the reaction time may be between about 15 minutes to about 48 hours, preferably about 1 hour to 24 hours, preferably about 12 to 24 hours. In some embodiments, the seeds may be incubated with the enzyme under a vacuum, in order to increase diffusion of the enzyme into the seeds and thereby the reaction rate.

Preferably the process is carried out between about pH 4.0 and about pH 10.0, more preferably between about pH 5.0 and about pH 10.0, more preferably between about pH 6.0 and about pH 10.0, more preferably between about pH 5.0 and about pH 7.0, more preferably between about pH 6.5 and about pH 7.5, e.g. at about pH 7.0 (i.e. neutral pH).

Pressing

In some embodiments, the treated seeds (e.g. seed flakes) are pressed following incubation with the enzyme. By “pressing” it is intended to refer to any application of mechanical force, which typically results in expulsion of a significant proportion of the oil from the oilseeds. This step may be performed using any suitable apparatus known in the art, e.g. continuous screw presses, expellers, single-screw or twin-screw extruders. Pressing may be performed, for example, using a one-stage or multistage process.

Expeller pressing typically reduces the oil content of the seed from e.g. (in the case of rapeseed) about 40% to about 20%. Solvent extraction methods, as are well known in the art, may then be used, if desired, to recover the remaining oil from the press-cake. In some embodiments, the oil obtained from pressing and/or solvent extraction may be further treated using a chlorophyllase or related enzyme, e.g. as described in WO2006/009676. However, it is an advantage of the present method that because chlorophyll is removed at the initial stage of oil recovery from the seed, a further chlorophyll removal step may not be required.

As disclosed in EP10156412.8, it has been found that the activity of chlorophyllases and related enzymes is dependent on the presence of phospholipids and/or other surfactants. Moreover elevated lysophospholipid levels are associated with reduced activity of chlorophyllases. Whilst oil obtained from seeds by solvent extraction may have a relatively high concentration of phospholipids, oil obtained by expeller pressing of seeds may have a much lower phospholipid content. Accordingly, it is an advantage that in the present process, the chlorophyllase is active at a stage when phospholipids are still present. If the chlorophyllase were to be contacted with oil after pressing, chlorophyllase activity would be likely to be lower due to the absence or very low levels of phospholipids. For similar reasons and as discussed above, where a phospholipase is used in the present process, it is preferred that the chlorophyllase is contacted with the seeds before or at the same time as the phospholipase and that the phospholipase does not produce lysophospholipids.

Oil Separation

Following treatment of the seeds using an enzyme according to the present invention, and optionally pressing and/or solvent extraction steps as described above, the treated liquid (e.g.

oil) may be separated with an appropriate means such as a centrifugal separator. The extracted oil may optionally be washed with water or organic or inorganic acid such as, e.g., acetic acid, citric acid, phosphoric acid, succinic acid, malic acid and the like, or with salt solutions.

Chlorophyll and/or Chlorophyll Derivative Removal

The process of the present invention involving treating seeds with a chlorophyllase or related enzyme typically reduces the level of chlorophyll and/or chlorophyll derivatives in the oil extracted from the seeds, compared to oil obtained from seeds which have not been enzyme treated. For example, the process may reduce the concentration of chlorophyll, pheophytin and/or pyropheophytin by at least 5%, at least 10%, at least 20%, at least 30%, at least 40%, at least 50%, at least 60%, at least 70%, at least 80%, at least 90%, at least 95% or at least 99%, compared to the concentration of chlorophyll, pheophytin and/or pyropheophytin (by weight) present in the oil obtained from untreated seeds. Thus in particular embodiments, the concentration of chlorophyll and/or chlorophyll derivatives in the extracted oil after treatment may be less than 100, less than 50, less than 30, less than 10, less than 5, less than 1, less than 0.5, less than 0.1 mg/kg or less than 0.02 mg/kg, based on the total weight of the oil.

Further Processing Steps

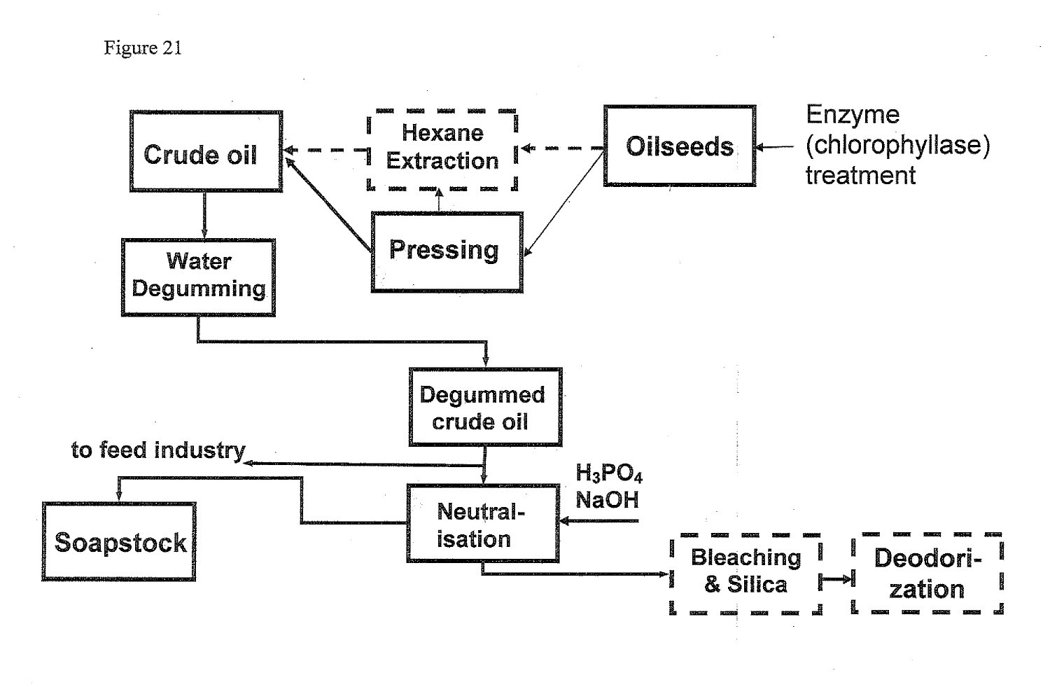

In a typical plant oil processing method, crude oil is obtained using pressing and/or hexane extraction, the crude vegetable oil is degummed, optionally caustic neutralized, bleached using, e.g. clay adsorption with subsequent clay disposal, and deodorized to produce refined, bleached and deodorized or RBD oil (see FIG. 21). The need for the degumming step depends on phosphorus content and other factors. The process of the present invention can be used in conjunction with processes based on extraction with hexane and/or enzyme assisted oil extraction (see Journal of Americal Oil Chemists' Society (2006), 83 (11), 973-979). In general, the process of the invention may be performed using oil processing steps as described in Bailey's Industrial Oil and Fat Products (2005), 6^{th} edition, Ed. by Fereidoon Shahidi, John Wiley & Sons, and as shown in FIG. 21. In some embodiments, the process may comprise a further chlorophyllase treatment at a later stage of the process (i.e. after treatment of the seeds), e.g. as described in EP10156412.8 or WO2006/009676.

Further processing steps, after treatment with the enzyme, may assist in removal of the products of enzymatic hydrolysis of chlorophyll and/or chlorophyll derivatives. For instance, further processing steps may remove chlorophyllide, pheophorbide, pyropheophorbide and/or phytol.

Degumming

The degumming step in oil refining serves to separate phosphatides by the addition of water. The material precipitated by degumming is separated and further processed to mixtures of lecithins. The commercial lecithins, such as soybean lecithin and sunflower lecithin, are semi-solid or very viscous materials. They consist of a mixture of polar lipids, primarily phospholipids such as phosphatidylcholine with a minor component of triglycerides. Thus as used herein, the term “degumming” means the refining of oil by removing phospholipids from the oil. In some embodiments, degumming may comprise a step of converting phosphatides (such as lecithin and phospholipids) into hydratable phosphatides.

The process of the invention can be used with any degumming procedure, including water degumming, ALCON oil degumming (e.g., for soybeans), safinco degumming, “super degumming,” UF degumming, TOP degumming, uni-degumming, dry degumming and ENZYVIAX™ degumming See e.g. U.S. Pat. Nos. 6,355,693; 6,162,623; 6,103,505; 6,001,640; 5,558,781; 5,264,367, 5,558,781; 5,288,619; 5,264,367; 6,001,640; 6,376,689; WO 0229022; WO 98118912; and the like. Various degumming procedures incorporated by the methods of the invention are described in Bockisch, M. (1998), Fats and Oils Handbook, The extraction of Vegetable Oils (Chapter 5), 345-445, AOCS Press, Champaign, Illinois.

Water degumming typically refers to a step in which the oil is incubated with water (e.g. 1 to 5% by weight) in order to remove phosphatides. Typically water degumming may be performed at elevated temperature, e.g. at 50 to 90° C. The oil/water mixture may be agitated for e.g. 5 to 60 minutes to allow separation of the phosphatides into the water phase, which is then removed from the oil.

Acid degumming may also be performed. For example, oil may be contacted with acid (e.g. 0.1 to 0.5% of a 50% solution of citric or malic acid) at 60 to 70° C., mixed, contacted with 1 to 5% water and cooled to 25 to 45 ° C.

Further suitable degumming procedures for use with the process of the present invention are described in WO 2006/008508. Acyltransferases suitable for use in the degumming step of the process are also described in WO 2004/064537, WO 2004/064987 and WO 2009/024736. Any enzyme having acyltransferase activity (generally classified as E.C.2.3.1) may be used, particularly enzymes comprising the amino acid sequence motif GDSX, wherein X is one or more of the following amino acid residues: L, A, V, I, F, Y, H, Q, T, N, M or S. In one embodiment, acyltransferase is a mutant Aeromonas salmonicida mature lipid acyltransferase (GCAT) with a mutation of Asn80Asp, e.g. an acyltransferase comprising the amino acid sequence of SEQ ID NO:23 after undergoing post-translational modification (see FIG. 22), or an enzyme having at least 80% sequence identity thereto. In one embodiment the lipid acyltransferase is Lysomax Oil® available from Danisco A/S, Denmark.

In another embodiment, the process comprises a degumming step in which the oil is contacted with a phospholipase. Phospholipases which may be used in the oil degumming step are generally as described above in relation to phospholipases which may be used in the seed treatment step. Any enzyme having e.g. a phospholipase A1 (E.C.3.1.1.32) or a phospholipase A2 (E.C.3.1.1.4) activity may be used, for example Lecitase Ultra® or pancreatic phospholipase A2 (Novozymes, Denmark). In one embodiment the process comprises performing an enzymatic degumming step using a phospholipase, for example using a degumming step as described in U.S. Pat. No. 5,264,367, EP 0622446, WO 00/32758 or Clausen (2001) “Enzymatic oil degumming by a novel microbial phospholipase,” Eur. J. Lipid Sci. Technol. 103:333-340.

Acid Treatment/Caustic Neutralization

In some embodiments, an acid treatment/caustic neutralization step may be performed in order to further reduce phospholipid levels in the oil after water degumming. In another embodiment, a single degumming step comprising acid treatment/caustic neutralization may be performed. Such methods are typically referred to as total degumming or alkali refining.

It has been found that an acid treatment/caustic neutralization step is particularly effective in removing products of the enzymatic hydrolysis of chlorophyll, e.g. chlorophyllide, pheophorbide and pyropheophorbide. Thus this step may be performed at any stage in the process after the enzyme treatment step. For example, such a step may comprise addition of an acid such as phosphoric acid followed by neutralization with an alkali such as sodium hydroxide. Following an acid/caustic neutralization treatment compounds such as chlorophyllide, pheophorbide and pyropheophorbide are extracted from the oil in an aqueous phase.

In such methods, the oil is typically first contacted with 0.05 to 0.5% by weight of concentrated phosphoric acid, e.g. at a temperature of 50 to 90° C., and mixed to help precipitate phosphatides. The contact time may be, e.g. 10 seconds to 30 minutes. Subsequently an aqueous solution of an alkali (e.g. 1 to 20% aqueous sodium hydroxide) is added, e.g. at a temperature of 50 to 90° C., followed by incubation and mixing for 10 seconds to 30 minutes. The oil may then be heated to about 90° C. and the aqueous soap phase separated from the oil by centrifugation.

Optionally, further wash steps with e.g. sodium hydroxide or water may also be performed.

Chlorophyllide, Pheophorbide and Pyropheophorbide Removal

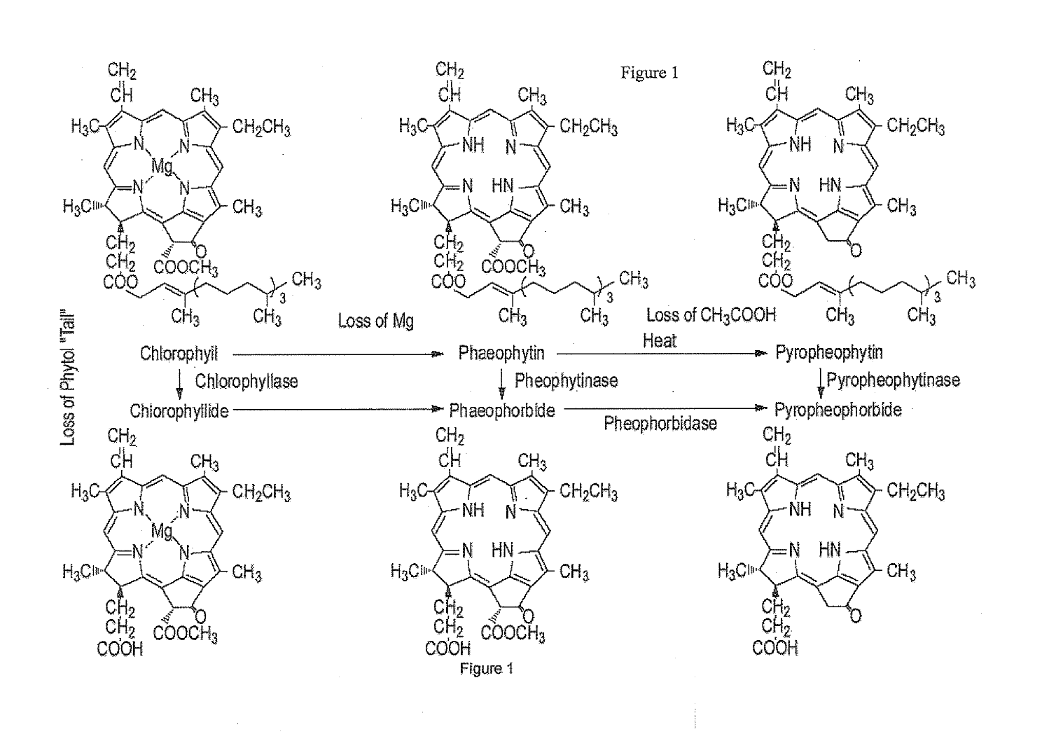

The method of the present invention may optionally involve a step of removing phytol-free derivatives of chlorophyll such as chlorophyllide, pheophorbide and pyropheophorbide. Such products may be present in the composition due to the hydrolysis of chlorophyll or a chlorophyll derivative by the enzyme of the invention, or may be present naturally, as a contaminant, or as an undesired component in a processed product. Pyropheophorbide may also be present in the composition due to the breakdown of pheophorbide, which may itself be produced by the activity of an enzyme having pheophytinase activity on pheophytin, or pheophorbide may be formed from chlorophyllide following the action of chlorophyllase on chlorophyll (see FIG. 1). Processing conditions used in oil refining, in particular heat, may favour the formation of pyropheophorbide as a dominant component, for instance by favouring the conversion of pheophytin to pyropheophytin, which is subsequently hydrolysed to pyropheophorbide.

In one embodiment the process of the present invention reduces the level of chlorophyllide, pheophorbide and/or pyropheophorbide in the oil, compared to either or both of the levels before and after enzyme treatment. Thus in some embodiments the chlorophyllide, pheophorbide and/or pyropheophorbide concentration may increase after enzyme treatment. Typically the process involves a step of removing chlorophyllide, pheophorbide and/or pyropheophorbide such that the concentration of such products is lower than after enzyme treatment. Preferably the chlorophyllide, pheophorbide and/or pyropheophorbide produced by this enzymatic step is removed from the oil, such that the final level of these products in the oil is lower than before enzyme treatment.

It is an advantage of the present process that reaction products such as chlorophyllide, pheophorbide and/or pyropheophorbide may be simply and easily removed from the oil by a step such as acid treatment/caustic neutralization. Thus in preferred embodiments chlorophyll and chlorophyll derivatives may be substantially removed from the oil without the need for further processing steps such as clay and/or silica treatment and deodorization.

Clay Treatment

It is preferred that the process does not comprise a clay treatment step. Avoiding the use of clay is advantageous as this reduces cost, reduces losses of oil through adherence to the clay and the increases retention of useful compounds such as carotenoids and tocopherol.

In some embodiments, the process may be performed with no clay treatment step and no deodorization step, which results in an increased concentration of such useful compounds in the refined oil, compared to a process involving clay treatment.

Silica Treatment

Although not always required, in some embodiments the process may comprise a step of silica treatment. For example, the method may comprise use of an adsorbent-free or reduced adsorbent silica refining devices and processes, which are known in the art, e.g., using TriSyl Silica Refining Processes (Grace Davison, Columbia, Md.), or, SORBSIL R™ silicas (INEOS Silicas, Joliet, Ill.).

The silica treatment step may be used to remove any remaining chlorophyllide, pheophorbide and/or pyropheophorbide or other polar components in the oil. For example, in some embodiments a silica treatment step may be used as an alternative to an acid treatment/caustic neutralization (total degumming or alkali refining) step.

In one embodiment the process comprises a two-stage silica treatment, e.g. comprising two silica treatment steps separated by a separation step in which the silica is removed, e.g. a filtration step. The silica treatment may be performed at elevated temperature, e.g. at above about 30° C., more preferably about 50 to 150° C., about 70 to 110° C., about 80 to 100° C. or about 85 to 95° C., most preferably about 90° C.

Deodorization

In some embodiments, the process may comprise a deodorization step, typically as the final refining step in the process. In one embodiment, deodorization refers to steam distillation of the oil, which typically removes volatile odor and flavor compounds, tocopherol, sterols, stanols, carotenoids and other nutrients. Typically the oil is heated to 220 to 260° C. under low pressure (e.g. 0.1 to 1 kPa) to exclude air. Steam (e.g. 1-3% by weight) is blown through the oil to remove volatile compounds, for example for 15 to 120 minutes. The aqueous distillate may be collected.

In another embodiment, deodorization may be performed using an inert gas (e.g. nitrogen) instead of steam. Thus the deodoriztion step may comprise bubble refining or sparging with an inert gas (e.g. nitrogen), for example as described by A. V. Tsiadi et al. in “Nitrogen bubble refining of sunflower oil in shallow pools”, Journal of the American Oil Chemists' Society (2001), Volume 78 (4), pages 381-385. The gaseous phase which has passed through the oil may be collected and optionally condensed, and/or volatile compounds extracted therefrom into an aqueous phase.

In some embodiments, the process of the present invention is performed with no clay treatment but comprising a deodorization step. Useful compounds (e.g. carotenoids, sterols, stanols and tocopherol) may be at least partially extracted from the oil in a distillate (e.g. an aqueous or nitrogenous distillate) obtained from the deodorization step. This distillate provides a valuable source of compounds such as carotenoids and tocopherol, which may be at least partially lost by entrainment in a process comprising clay treatment.

The loss of tocopherol during bleaching depends on bleaching conditions and the type of clay applied, but 20-40% removal of tocopherol in the bleaching step has been reported (K. Bold, M, Kubo, T. Wada, and T. Tamura, ibid., 69, 323 (1992)). During processing of soy bean oil a loss of 13% tocopherol in the bleaching step has been reported (S. Ramamurthi, A. R. McCurdy, and R. T. Tyler, in S. S. Koseoglu, K. C. Rhee, and R. F. Wilson, eds., Proc. World. Conf. Oilseed Edible Oils Process, vol. 1, AOCS Press, Champaign, Illinois, 1998, pp. 130-134).

Carotenoids may be removed from the oil during deodorization in both clay-treated and non-clay-treated oil. Typically the removal of coloured carotenoids is controlled in order to produce an oil having a predetermined colour within a specified range of values. The level of carotenoids and other volatile compounds in the refined oil can be varied by modifying the deodorization step. For instance, in an embodiment where it is desired to retain a higher concentration of carotenoids in the oil, the deodorization step may be performed at a lower temperature (e.g. using steam at 200° C. or below). In such embodiments it is particularly preferable to avoid a clay treatment step, since this will result in a higher concentration of carotenoids in the refined oil.

The invention will now be further illustrated with reference to the following non-limiting examples.

### EXAMPLE 1

Cloning and Expression of a Chlorophyllase from Triticum aestivum (Wheat) in Bacillus subtilis

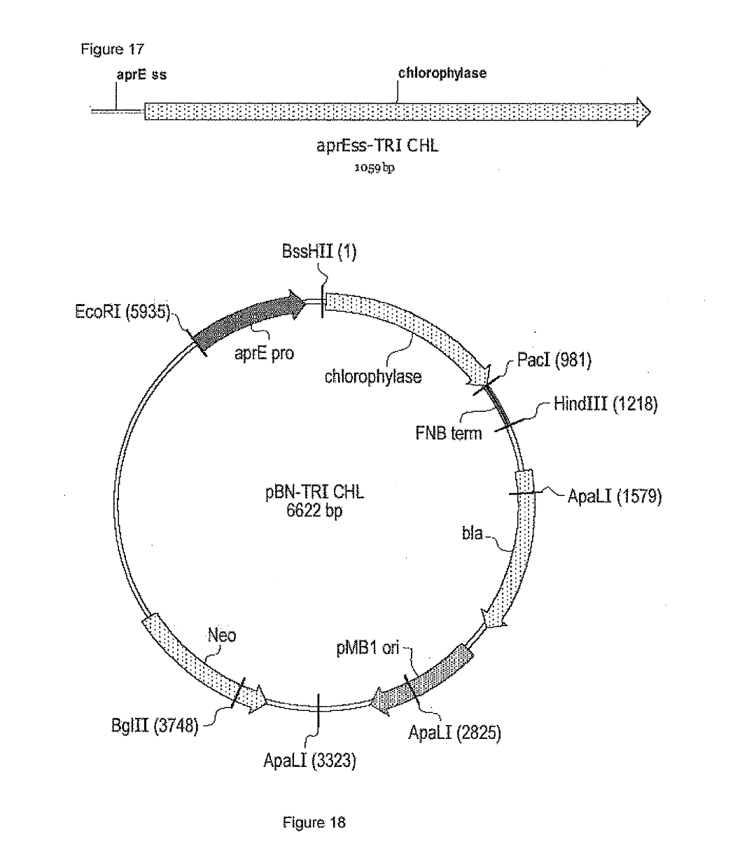

A nucleotide sequence (SEQ ID No. 3) encoding a wheat chlorophyllase (SEQ. ID No. 2, hereinafter wheat chlase) was expressed in Bacillus subtilis with the signal peptide of a B. subtilis alkaline protease (aprE) (see FIG. 17). For optimal expression in Bacillus, a codon optimized gene construct (TRI_CHL) was ordered at GenScript (GenScript Corporation, Piscataway, N.J. 08854, USA).

The construct TRI_CHL contains 20 nucleotides with a BssHII restriction site upstream to the wheat chlase coding region to allow fusion to the aprE signal sequence and a PacI restriction site following the coding region for cloning into the bacillus expression vector pBNppt.

The construct TRI_CHL was digested with BssHII and Pad and ligated with T4 DNA ligase into BssHII and PacI digested pBNppt.

The ligation mixture was transformed into E. coli TOP 10 cells. The sequence of the BssHII and Pac insert containing the TRI_CHL gene was confirmed by DNA sequencing (DNA Technology A/S, Risskov, Denmark) and one of the correct plasmid clones was designated pBN-TRI_CHL (FIG. 18). pBN-TRI_CHL was transformed into B. subtilis strain BG 6002 a derivative of AK 2200, as described in WO 2003/099843.

One neomycin resistant (neoR) transformant was selected and used for expression of the wheat chlase.

### EXAMPLE 2

Cloning and Expression of a Chlorophyllase from Chlamydomonas reinhardtii (Green Algae) in Bacillus subtilis

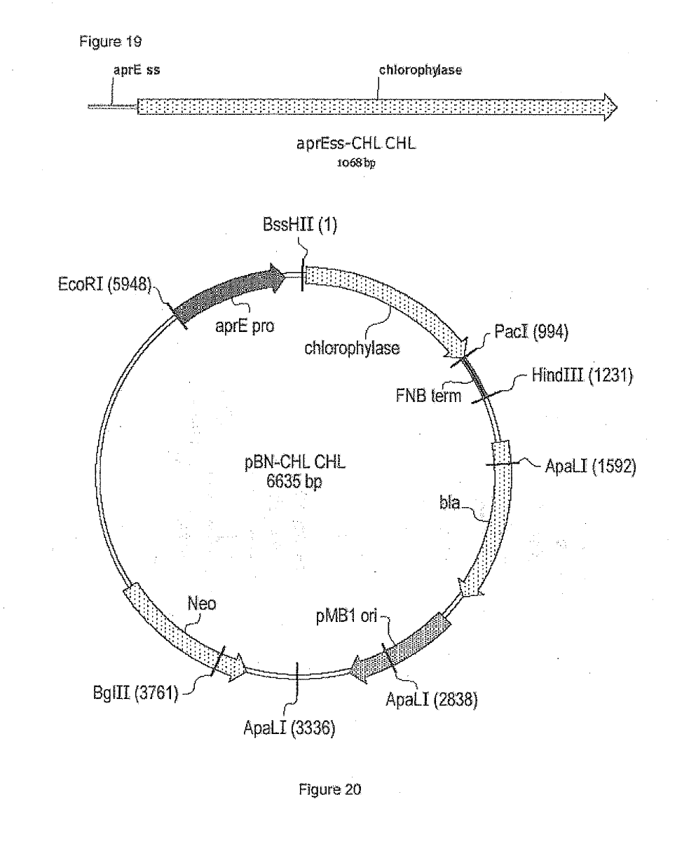

A nucleotide sequence (SEQ ID No. 5) encoding a Chlamydomonas chloryphyllase (SEQ. ID No. 4, hereinafter chlamy chlase) was expressed in Bacillus subtilis with the signal peptide of a B. subtilis alkaline protease (aprE) (see FIGS. 19 and 20). For optimal expression in Bacillus, a codon optimized gene construct (CHL_CHL) was ordered at GenScript (GenScript Corporation, Piscataway, N.J. 08854, USA).

The construct CHL_CHL contains 20 nucleotides with a BssHII restriction site upstream to the chlamy chlase coding region to allow fusion to the aprE signal sequence and a PacI restriction site following the coding region for cloning into the bacillus expression vector pBNppt.

The construct CHL_CHL was digested with BssHII and Pad and ligated with T4 DNA ligase into BssHII and PacI digested pBNppt.

The ligation mixture was transformed into E. coli TOP10 cells. The sequence of the BssHII and Pac insert containing the CHL_CHL gene was confirmed by DNA sequencing (DNA Technology A/S, Risskov, Denmark) and one of the correct plasmid clones was designated pBN-CHL_CHL (FIG. 20). pBN-CHL_CHL was transformed into B. subtilis strain BG 6002 a derivative of AK 2200, as described in WO 2003/099843.

One neomycin resistant (neoR) transformant was selected and used for expression of the chlamy chlase.

### EXAMPLE 3

Treatment of Rapeseed with Chlorophyllase from Triticum aestivum (Wheat)

The chlorophyllase from Triticum (see Example 1) is very active on chlorophyll, pheophytin and pyropheophytin in crude rapeseed oil and crude soya oil isolated from seeds by solvent extraction. The solvent extraction results in a relatively high content of phospholipids in the crude oil (1-2%). It has been shown that it is essential for good chlorophyllase activity to have a rather high level of phospholipid in the oil.

Oils like rapeseed oil are however not always produced by solvent extraction of the oil, but a large part is produced by expeller pressing of the seed (see Bailey's Industrial Oil and Fat Products (2005), 6^{th} edition, Ed. by Fereidoon Shahidi, John Wiley & Sons, Chapter 2.2). Oil obtained by pressing of rapeseed has a much lower content of phospholipids. In pressed rapeseed oil chlorophyllase activity would be lower because of the lower content of phospholipids. Accordingly, in the present example, chlorophyllase was added to the seeds before oil pressing.

In this example, rapeseed (from Scanola, Denmark) was conditioned and flaked. In the experiments conducted the enzyme was added to the flaked seed, because this allows a better penetration of the enzyme into the seeds. Rapeseed was flaked (0.3 mm) on a roller mill.

A chlorophyllase from Triticum expressed in E-coli and purified, labelled CoRe-43, was added to oil seed in amounts as shown below in Table 1. The enzyme preparations Rohalase OS® (a mixture comprising cellulase, beta-glucanase and xylanase activities from AB Enzymes, Germany) and Purifine® (phospholipase C, from Verenium Corporation, US) were also added as shown in Table 1.

TABLE 1

| | | 1 | 2 | 3 | 4 |
|---|---|---|---|---|---|
| Flaked rapeseed | g | 250 | 250 | 250 | 250 |
| Rohalase OS diluted 1:5 | ml | 1 | 1 | 1 | |
| Purifine Diluted 1:5 | ml | | | 1 | 1 |
| Chlorophyllase Core 43 | ml | | 2.42 | 2.42 | |
| diluted 1:3 | | | | | |
| Water | | 4 | 1.58 | 0.58 | 4.00 |
| Rohalase OS | ppm | 800 | 800 | 800 | |
| Purifine | ppm | | | 800 | 800 |
| Chlorophyllase Core 43 | U/g | | 0.1 | 0.1 | |
| Water | % | 2 | 2 | 2 | 2 |

Enzymes and water were sprayed onto the flaked seeds and incubated at 45° C. for 16 hours. The seeds were then pressed on an expeller oil press Type 20 from Skeppsta Maskin AB, Sweden. The oil yield from experiments 1, 2, 3 and 4 were 26%, 26.6%, 28% and 27.6% respectively. The oil isolated from the press was centrifuged at 10000 ref for 5 minutes and then analysed by HPLC/MS (table 2).

TABLE 2
HPLC/MS analysis of pressed rapeseed oil

| | 1 | 2 | 3 | 4 |
|---|---|---|---|---|
| | ppm | ppm | ppm | ppm |
| Pheophorbide | 0.22 | 0.30 | 0.26 | 0.19 |
| Pyropheophorbide | 0.23 | 0.13 | 0.12 | 0.18 |
| Pheophytin b | 0.23 | 0.13 | 0.12 | 0.18 |
| Pheophytin a | 3.69 | 1.77 | 1.62 | 2.71 |
| Pyropheophytin | 0.05 | 0.03 | 0.04 | 0.05 |
| Chlorophyll b | 0.22 | 0.12 | 0.16 | 0.21 |
| Chlorophyll a | 0.68 | 0.47 | 0.57 | 0.66 |

The results from HPLC/MS analysis (table 2) confirm that the chlorophyllase was active in the oilseeds. Approximately 50% of the pheophytin was degraded in the chlorophyllase treated sample. Significant amounts of chlorophyll and pyropheophytin were also degraded. The concentration of pheophorbide increased in the chlorophyllase-treated samples, consistent with degradation of pheophytin, although it appears that some of the pheophorbide formed may be absorbed in the rapeseed meal and does not appear in the extracted oil.

All publications mentioned in the above specification are herein incorporated by reference. Various modifications and variations of the described methods and system of the present invention will be apparent to those skilled in the art without departing from the scope and spirit of the present invention. Although the present invention has been described in connection with specific preferred embodiments, it should be understood that the invention as claimed should not be unduly limited to such specific embodiments. Indeed, various modifications of the described modes for carrying out the invention which are obvious to those skilled in biochemistry and biotechnology or related fields are intended to be within the scope of the following claims.

1. A process for treating oil-containing seeds, comprising a step of contacting the seeds with an enzyme which is capable of hydrolyzing chlorophyll or a chlorophyll derivative.

2. A process according to claim 1, wherein the seeds are flaked, peeled or crushed before contacting with the enzyme.

3. A process according to claim 2, wherein the seeds comprise seed flakes having a thickness of about 0.1 to 0.5 mm.

4. A process according to claim 1, wherein the enzyme is sprayed onto the seeds in an aqueous solution.

5. A process according to claim 1, wherein the enzyme comprises a chlorophyllase, pheophytinase, pyropheophytinase or pheophytin pheophorbide hydrolase.

6. A process according to claim 1, wherein the enzyme comprises a polypeptide sequence as defined in any one of SEQ ID NOs: 1, 2, 4, 6 or 8 to 15, or a functional fragment or variant thereof.

7. A process according to claim 6, wherein the enzyme comprises a polypeptide sequence having at least 75% sequence identity to any one of SEQ ID NOs: 1, 2, 4, 6 or 8 to 15 over at least 50 amino acid residues.

8. A process according to claim 1, further comprising contacting the seeds with one or more further enzymes selected from cellulases, endoglucanases, cellobiohydrolases, hemicellulases, pectinases, phospholipases, lipid acyl transferases, proteases and phytases.

9. A process according to claim 8, wherein the seeds are contacted with a phospholipase C.

10. A process according to claim 8, wherein the seeds are contacted with a lipid acyltransferase.

11. A process according to claim 1, wherein the seeds are selected from soya beans, peanuts, cotton seeds, sunflower seeds and rapeseeds, preferably soya or rapeseed.

12. A method for obtaining oil from plant seeds, comprising
a) treating the seeds by a process as defined in claim 1;
b) pressing the treated seeds; and
c) recovering oil from the pressed seeds.

13. A process for producing a refined plant oil, comprising obtaining a crude oil by a method as defined in claim 12, and refining the crude oil to obtain a refined plant oil.

14. A process according to claim 13, wherein the process comprises a degumming step comprising addition of an acid to the oil followed by neutralisation with an alkali.

15. A process according to claim 13, wherein the process does not comprise a step of clay treatment.

16. A process according to any of claims 13, wherein the process further comprises performing a deodorisation step to produce a deodorized oil and a distillate.

17. A crude or refined plant oil obtainable by a method or process as defined in any of claims 12.
